(19) United States
(12) Patent Application Publication
(10) Pub. No.: US 2009/0252834 A1
(43) Pub. Date: Oct. 8, 2009

(54) Compositions comprising glucose anti-metabolites

(76) Inventors: Michael Griffin Hayek, Dayton, OH (US); Stefan Patrick Massimino, Portland, OR (US); George S. Roth, Pylesville, MP (US); Gary Mitchell Davenport, Dayton, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/371,266

(22) Filed: Feb. 13, 2009

Related U.S. Application Data
(63) Continuation-in-part of application No. 10/842,301, filed on May 10, 2004.

(51) Int. Cl. A23L 1/30; A23L 1/39; A23L 2/38; A23C 21/08; A23L 1/0522

(52) U.S. Cl. 426/66; 426/648; 426/589; 426/583; 426/578

(57) ABSTRACT

Disclosed herein are compositions comprising mannoheptulose. The compositions may be in the form of treats, kibbles, supplements, gravies, drinking waters, yoghurts, powders, suspensions and combinations thereof. The composition may be nutritionally balanced. The composition may be partially extruded.

### CROSS REFERENCE TO RELATED APPLICATION

This application is a Continuation-in-Part of U.S. application Ser. No. 10/842,301, May 10, 2004.

### FIELD OF THE INVENTION

The present invention is directed to compositions comprising a selected carbohydrate component, or extract of plant material selected from avocado, alfalfa, fig, primrose, and mixtures thereof. In an embodiment, the present invention relates to the use of glucose anti-metabolites to mimic effects of caloric restriction for the purpose of maintaining and/or attenuating a decline in the quality of life of a mammal.

### BACKGROUND OF THE INVENTION

Studies have indicated that restriction of caloric intake by food deprivation slows down certain undesirable cellular processes in laboratory animals, many associated with aging and age-related diseases.

In particular, caloric restriction has been shown to consistently extend the life span, delay onset and slow tumor progression, and retard physiologic aging in many systems. Indeed, research spanning more than sixty years has shown that caloric restriction is a nutritional intervention that consistently extends longevity in animals. See Weindruch and Walford, “The Retardation of Aging and Disease by Dietary Restriction,” Springfield, Ill.: Charles C. Thomas (1988); Yu, “Modulation of Aging Processes by Dietary Restriction,” Boca Raton: CRC Press (1994); and Fishbein, “Biological Effects of Dietary Restriction,” Springer, N.Y. (1991). These effects of caloric restriction on life span and tumorigenesis have been reported numerous times since the early studies of McKay. See McKay et al., “The Effect of Retarded Growth Upon the Length of Lifespan and Upon Ultimate Body Size,” J. Nutr., Vol. 10, pp. 63-79 (1935). Indeed, over the past two decades, a resurgence of interest in caloric restriction in gerontology has led to the general acceptance that this dietary manipulation slows physiologic aging in many systems. See Weindruch and Walford, “The Retardation of Aging and Disease by Dietary Restriction,” Springfield, Ill.: Charles C. Thomas (1988); Yu, “Modulation of Aging Processes by Dietary Restriction,” Boca Raton: CRC Press (1994); and Fishbein, “Biological Effects of Dietary Restriction,” Springer, N.Y. (1991) and Masoro, E. J. “Overview of Caloric Restriction and Ageing,” Mech. Aging Dev., Vol. 126, pp 913-922 (2005).

Reductions in fasting glucose and insulin levels and improvements in insulin sensitivity are readily measured biomarkers of caloric restriction. Calorically restricted rodents exhibit lower fasting glucose and insulin levels, and the peak glucose and insulin levels reached during a glucose challenge are reduced in those on caloric restriction. See Kalant et al., “Effect of Diet Restriction on Glucose Metabolism and Insulin Repsonsiveness and Aging Rats,” Mech. Aging Dev., Vol. 46, pp. 89-104 (1988). It is also known that hyperinsulinemia is a risk factor associated with several such disease processes, including heart disease and diabetes (Balkau and Eschwege, Diabetes Obes. Metab. 1 (Suppl. 1): S23-31, 1999). Reduced insulin levels and body temperature are two of the most reliable indicators of this altered metabolic profile (Masoro et al., J. Gerontol. Biol. Sci. 47:B202-B208, 1992); Koizumi et al., J. Nutr. 117: 361-367, 1987; Lane et al., Proc. Nat. Acad. Sci. 93:4154-4164, 1996).

Components such as 2-deoxy-D-glucose have been described which block or inhibit certain aspects of carbohydrate metabolism and may therefore mimic the effects of caloric restriction (Rezek et al., J. Nutr. 106:143-157, 1972; U.S. Patent Application Publication No. 2002/0035071). These components exert a number of physiological effects, including reduction of body weight, decrease in plasma insulin levels, reduction of body temperature, retardation of tumor formation and growth, and elevation of circulating glucocorticoid hormone concentrations. (For a review see Roth et al., Ann. NY Acad. Sci. 928:305-315, 2001). These physiological effects result from inhibition of carbohydrate metabolism.

However, the commercial utility of such components has been limited, particularly as practical applications had yet been identified. It would be beneficial to provide compositions which may be commercially utilized, and further provide processes for preparation of such compositions. In particular, it has been found that the components herein may be processed from plant matter, or otherwise provided, and then subjected to traditional processing methods (such as, for example, extrusion or other such vigorous methods) without compromising the integrity of the component. It would be beneficial to provide glucose anti-metabolites having physiological effects on the cellular processes associated with aging and age-related diseases wherein the physiological effects maintain and/or attenuate a decline in the quality of life of a mammal. It would be beneficial to provide glucose anti-metabolites for maintaining and/or attenuating a decline in the quality of life of a mammal, such as, but not limited to, maintaining and/or attenuating a decline in the whole body composition and maintaining and/or attenuating a decline in the functional mobility of a mammal.

### SUMMARY OF THE INVENTION

A composition comprising an effective amount of mannoheptulose wherein the effective amount of mannoheptulose provides a dosage to a mammal on a daily basis from about 0.001 gram per kilogram body weight of the mammal to about 1 gram per kilogram body weight of the mammal, wherein the composition is nutritionally balanced.

A composition comprising an effective amount of mannoheptulose wherein the effective amount of mannoheptulose provides a dosage to a mammal on a daily basis from about 0.001 gram per kilogram body weight of the mammal to about 1 gram per kilogram body weight of the mammal, wherein the composition is a treat.

A composition comprising an effective amount of mannoheptulose wherein the effective amount of mannoheptulose provides a dosage to a mammal on a daily basis from about 0.001 gram per kilogram body weight of the mammal to about 1 gram per kilogram body weight of the mammal, wherein the composition is at least partially extruded.

A composition comprising an effective amount of mannoheptulose wherein the effective amount of mannoheptulose provides a dosage to a mammal on a daily basis from about 0.001 gram per kilogram body weight of the mammal to about 1 gram per kilogram body weight of the mammal, wherein the composition is in the form of a kibble.

A composition comprising an effective amount of mannoheptulose wherein the effective amount of mannoheptulose provides a dosage to a mammal on a daily basis from about 0.001 gram per kilogram body weight of the mammal to about 1 gram per kg of body weight of the mammal, wherein the composition is a supplement.

A composition comprising an effective amount of mannoheptulose wherein the effective amount of mannoheptulose provides a dosage to a mammal on a daily basis from about 0.001 gram per kilogram body weight of the mammal to about 1 gram per kg of body weight of the mammal, wherein the composition is selected from the group consisting of gravies, drinking waters, yoghurts, powders, suspensions and combinations thereof.

### BRIEF DESCRIPTION OF THE DRAWINGS

FIG. 1 is a graphical presentation of serial concentrations of plasma mannoheptulose in adult Labrador Retrievers fed a single meal of a nutritionally balanced composition containing mannoheptulose at a dose of 0, 1 or 2 mg/kg of the body weight of the dog.

FIG. 2 is a graphical presentation of serial concentrations of plasma mannoheptulose in adult Labrador Retrievers fed two equal meals of a nutritionally balanced composition containing mannoheptulose at a dose of 2 mg/kg of the body weight of the dog.

FIG. 3 is a graphical presentation of the average yearly lean body mass of older dogs over a 4 year period of feeding a nutritionally balanced composition containing mannoheptulose at a dose of 0 or 2 mg/kg of the body weight of the dog.

FIG. 4 is a graphical presentation of the average yearly bone mineral density of older dogs over a 4 year period of feeding a nutritionally balanced composition containing mannoheptulose at a dose of 0 or 2 mg/kg of the body weight of the dog.

FIG. 5 is a graphical presentation of the average yearly bone mineral content of older dogs over a 4 year period of feeding a nutritionally balanced composition containing mannoheptulose at a dose of 0 or 2 mg/kg of the body weight of the dog.

FIG. 6 is a graphical presentation of the average muscle strength, expressed as muscle power, of older dogs during months 19 through 46 of a 4 year period of feeding nutritionally balanced compositions containing mannoheptulose at a dose of 0 or 2 mg/kg of the body weight of the dog. The initial muscle strength is reported at month 22 of the study.

FIG. 7 is a graphical presentation of the percentage of older dogs successfully jumping over various heights relative to their individual shoulder height over one year of a 4 year period of feeding nutritionally balanced compositions containing mannoheptulose at a dose of 0 or 2 mg/kg of body weight of the dog. Jumping ability is assessed during 4 consecutive quarters beginning in month 37.

FIG. 8 is a graphical presentation of the percentage of older dogs successfully jumping onto table platforms of various heights relative to their individual shoulder height over one year of a 4 year period of feeding nutritionally balanced compositions containing mannoheptulose at a dose of 0 or 2 mg/kg of body weight of the dog. Jumping ability is assessed during 4 consecutive quarters beginning in month 37.

FIG. 9 is a graphical presentation of the average yearly lean body mass of younger dogs over a 3 year period of feeding a nutritionally balanced composition containing mannoheptulose at a dose of 0 or 2 mg/kg of the body weight of the dog.

FIG. 10 is a graphical presentation of the average yearly bone mineral density of younger dogs over a 3 year period of feeding a nutritionally balanced composition containing mannoheptulose at a dose of 0 or 2 mg/kg of the body weight of the dog.

FIG. 11 is a graphical presentation of the average yearly bone mineral content of younger dogs over a 3 year period of feeding a nutritionally balanced composition containing mannoheptulose at a dose of 0 or 2 mg/kg of the body weight of the dog.

FIG. 12 is a graphical presentation of the average muscle strength, expressed as muscle power, of younger dogs during months 6 through 32 of a 3 year period of feeding nutritionally balanced compositions containing mannoheptulose at a dose of 0 or 2 mg/kg of the body weight of the dog. The initial muscle strength is reported at month 8 of the study.

FIG. 13 is a graphical presentation of the percentage of younger dogs successfully jumping over various heights relative to their individual shoulder height over one year of a 3 year period of feeding nutritionally balanced compositions containing mannoheptulose at a dose of 0 or 2 mg/kg of body weight of the dog. Jumping ability is assessed during 4 consecutive quarters beginning in month 8.

FIG. 14 is a graphical presentation of the percentage of younger dogs successfully jumping onto table platforms of various heights relative to their individual shoulder height over one year of a 3 year period of feeding nutritionally balanced compositions containing mannoheptulose at a dose of 0 or 2 mg/kg of body weight of the dog. Jumping ability is assessed during 4 consecutive quarters beginning in month 8.

FIG. 15 is a right side view of a skeleton of a dog.

### DETAILED DESCRIPTION OF THE INVENTION

Various documents including, for example, publications and patents, are recited throughout this disclosure. All such documents are hereby incorporated by reference. The citation of any given document is not to be construed as an admission that it is prior art with respect to the present invention.

All percentages and ratios are calculated by weight unless otherwise indicated. All percentages and ratios are calculated based on the total composition unless otherwise indicated.

Referenced herein are trade names for components including various ingredients utilized in the present invention. The inventors herein do not intend to be limited by materials under a certain trade name. Equivalent materials (e.g., those obtained from a different source under a different name or reference number) to those referenced by trade name may be substituted and utilized in the descriptions herein.

In the description of the invention various embodiments or individual features are disclosed. As will be apparent to the ordinarily skilled practitioner, all combinations of such embodiments and features are possible and can result in preferred executions of the present invention.

The compositions herein may comprise, consist essentially of, or consist of any of the features or embodiments as described herein.

While various embodiments and individual features of the present invention have been illustrated and described, various other changes and modifications can be made without departing from the spirit and scope of the invention. As will also be apparent, all combinations of the embodiments and features taught in the foregoing disclosure are possible and can result in preferred executions of the invention.

All oral doses of the invention are calculated per kilogram of body weight of the mammal unless otherwise indicated.

### Compositions of the Present Invention

In one embodiment, the invention is directed to compositions comprising a glucose anti-metabolite component selected from the group consisting of 2-deoxy-D-glucose; 5-thio-D-glucose; 3-O-methylglucose; 1,5-anhydro-D-glucitol; 2,5-anhydro-D-glucitol; 2,5-anhydro-D-mannitol; mannoheptulose; and mixtures thereof. Without intending to be limited by theory, it is believed that these components are glucose anti-metabolites. See e.g., U.S. Patent Application Publication No. 2002/0035071. In another embodiment, the components may be present in the recited compositions by virtue of a component of plant matter such as avocado, or other enriched source of mannoheptulose such as alfalfa, fig, primrose and the like. The present invention is also directed to the use of such compositions for maintaining and/or attenuating a decline in the quality of life of a mammal such as a companion animal. Maintaining and/or attenuating a decline in the quality of life of a mammal includes, but is not limited to, maintaining and/or attenuating a decline in the whole body composition and maintaining and/or attenuating a decline in the functional mobility of a mammal. Maintaining and/or attenuating a decline in the whole body composition of a mammal is maintaining and/or attenuating a decline in the musculoskeletal health of the mammal. Maintaining and/or attenuating a decline in the musculoskeletal health of a mammal is maintaining and/or attenuating a decline in the muscle health and/or skeletal health of the mammal. Maintaining and/or attenuating a decline in the muscle health of a mammal is the maintenance and/or the attenuation of a decline in the lean body mass and/or the muscle strength of the mammal. Maintaining and/or attenuating a decline in the skeletal health of a mammal is the maintenance and/or the attenuation of a decline in the bone mineral density and/or the bone mineral content of the mammal. Maintaining and/or attenuating a decline in the functional mobility of a mammal is maintaining and/or attenuating a decline in the activities of daily living of the mammal. Maintaining and/or attenuating a decline in the activities of daily living is maintaining and/or attenuating a decline in activities such as, but not limited to, playing, walking, climbing, jumping, and running. For example, maintaining and/or attenuating a decline in a jumping activity of a mammal is the maintenance and/or the attenuation of a decline in the ability to jump over obstacles and/or onto surfaces.

The inclusion of glucose anti-metabolite components as part of the compositions herein are useful, for example, to alter utilization of glucose or other carbohydrate sources and to mimic metabolic effects of caloric restriction. Without intending to be limited by theory, the present use of glucose anti-metabolite components to alter glucose metabolism serves to lower the metabolic rate through inhibition of glucose as an energy source on the cellular level. Judicious use of components that block the normal metabolism of cellular glucose can result in changes in physiological function that are similar to those arising from caloric restriction. Caloric restriction has been consistently shown to extend longevity in animals. See Weindruch and Walford, “The Retardation of Aging and Disease by Dietary Restriction,” Springfield, Ill.: Charles C. Thomas (1988); Yu, “Modulation of Aging Processes by Dietary Restriction,” Boca Raton: CRC Press (1994); and Fishbein, “Biological Effects of Dietary Restriction,” Springer, N.Y. (1991).

In one embodiment herein, the invention relates to a method of maintaining and/or attenuating a decline in the health, functional activity, and/or biomarkers of longevity in a mammal, the method comprising administration of a composition comprising a glucose anti-metabolite component to the mammal. In another embodiment, the invention relates to a method of maintaining and/or attenuating a decline in the health, functional activity, and/or biomarkers of longevity in a mammal, the method comprising administration of a composition comprising avocado extract, wherein the avocado extract comprises mannoheptulose. In another embodiment, the invention relates to a method of maintaining and/or attenuating a decline in the health, functional activity, and/or biomarkers of longevity in a mammal, the method comprising administration of a composition comprising avocado meal, wherein the avocado meal comprises mannoheptulose. In yet another embodiment, the invention relates to a method of maintaining and/or attenuating a decline in the health, functional activity, and/or biomarkers of longevity in a mammal, the method comprising administration of a composition comprising mannoheptulose. As used herein, “maintaining and/or attenuating a decline in the health, functional activity, and biomarkers of longevity,” with reference to a mammal, includes both qualitative and quantitative measures, such as, for example, prolonging the life span of the mammal, retarding the physiological aging process, reducing incidence of disease, maintaining vitality, and combinations thereof.

In an embodiment, the invention relates to a method of maintaining and/or attenuating a decline in the quality of life of a mammal. The ability of the invention to maintain and/or attenuate a decline in the quality of life may be demonstrated by, but not limited to, maintaining and/or attenuating a decline in the whole body composition, maintaining and/or attenuating a decline in the functional mobility of a mammal and combinations thereof. Maintaining and/or attenuating a decline in the whole body composition of a mammal is maintaining and/or attenuating a decline in the musculoskeletal health of the mammal. Maintaining and/or attenuating a decline in the musculoskeletal health of a mammal is maintaining and/or attenuating a decline in the muscle health and/or skeletal health of the mammal. Maintaining and/or attenuating a decline in the muscle health of a mammal is the maintenance and/or the attenuation of a decline in the lean body mass and/or the muscle strength of the mammal. It is believed that maintenance and/or attenuation of a decline in the lean body mass and/or the muscle strength provides for maintenance and/or attenuation of a decline in muscle functionality such as, but not limited to, power and flexibility. Maintaining and/or attenuating a decline in the skeletal health of a mammal is the maintenance and/or the attenuation of a decline in the bone mineral density and/or the bone mineral content of the mammal. Maintaining and/or attenuating a decline in the functional mobility of a mammal is maintaining and/or attenuating a decline in the activities of daily living of the mammal. Maintaining and/or attenuating a decline in the activities of daily living is maintaining and/or attenuating a decline in activities such as, but not limited to, playing, walking, climbing, jumping, and running. For example, maintaining and/or attenuating a decline in a jumping activity of a mammal is the maintenance and/or the attenuation of a decline in the ability to jump over obstacles and/or onto surfaces. The maintenance and/or attenuation in the decline of body composition and functional mobility allow the mammal to maintain normal levels of voluntary activity despite advancing in age. It is widely accepted by those skilled in the art that mobility, locomotion, movement and/or activity of a mammal requires a healthy and functional musculoskeletal system comprised of bones (skeleton), muscles, and various connective tissues and structures such as cartilage, tendons, ligaments and joints. The invention may maintain and/or attenuate a decline in the measures of locomotion, mobility and/or activity such as, but not limited to, gait, velocity, symmetry, rate of speed, distance traveled, episodes of movement, stamina and endurance. These may result in the maintenance and/or attenuation of a decline in the activities of daily living such as playing, walking, running, jumping, climbing, ascending stairs, descending stairs, standing up, lying down, sleeping and social companionship. Additional benefits may extend to performance mammals engaged in enhanced levels of physical activity and/or sports such as, but not limited to, hunting, sprinting, running, pulling, sledding, retrieving, and agility. The ability to maintain and/or attenuate a decline in these regular and performance activities with advancing age lead to maintenance and/or attenuation of a decline in the quality of life of the mammal. Maintenance and/or attenuation of a decline in the quality of life of a mammal may also include a reduction of body fat, adiposity and/or the control of obesity.

In an embodiment, the invention may maintain and/or attenuate a decline in the immune system of the mammal. Immunity is divided into natural and adaptive immunity. The adaptive branch of the immune system is represented by cellular and humoral immunity and is defined by improved T and B cell responses. These responses are measured by assays such as, but not limited to, tritiated thymidine lymphoproliferative response, altered relative and absolute percent of white blood cell populations as measured by immunofluorescence, Th1 and Th2 cytokine profile changes as measured by commercially available assays, antibody titer production response to vaccine and other antigens, decreased series 2 and 4 eicosanoid and thromboxane production, and increased series 3 and 5 eicosanoid and thromboxane production as measured by commercially available kits. Assessment of the natural or innate branch of the immune system is based on the increased natural killer cell cytotoxic response as measured by Cr-51 release assay.

In an embodiment, the invention may maintain and/or attenuate a decline in the health, functional activity, and/or biomarkers of longevity by reducing the incidence of diseases that include, and are not limited to, obesity, diabetes, thyroid disease, heart disease, metabolic syndrome, Alzheimer's disease, Parkinson's disease, stroke, and cancer. The incidence of these diseases may be reduced by the ability of the invention to manage oxidative stress and inflammation. Maintenance and/or attenuation in the decline of the health of the mammal may be reflected in biomarkers of longevity such as body temperature, insulin, insulin sensitivity Health screening by licensed health care practitioners using standard methods such as physical examinations, blood chemistries, complete blood counts, radiographs, MRI, and CT-scans may show the benefits of the invention on the successful aging and quality of life of the mammal.

Additional quality of life benefits include, but are not limited to, the interaction of the individual with its environment such as behavior, temperament, companionship, social well-being, response to stress, cognition and sensorial abilities including vision, hearing, smell, taste, touch, and satiety. Additional quality of life benefits include, and are not limited to, improved physical appearance such as physique, stature, body condition, skin condition, hair condition, and a more desirable social bond, such as the bond between a human and a companion animal. Additional quality of life benefits may be reflected in various calculated indices of health, wellness, mobility, activity, vitality, frailty, functional living, healthspan, and active longevity.

The ability of the invention to maintain and/or attenuate a decline in the quality of life can be linked to the presence of glucose anti-metabolite components in various biological fluids and tissues following administration of the compositions of the invention to the mammal. These biological fluids include but are not limited to feces, urine, blood, saliva, perspiration, spinal fluid, synovial fluid, milk. Biological tissues include but are not limited to liver, muscle, adipose, kidney, gastrointestinal, buccal, nasal, skin, hair, and/or the cells derived from these tissues.

The mammal treated herein includes vertebrates and invertebrates such as for example insects (e.g., the fruit fly) and/or nematodes (e.g., Caenorbabditis elegans). Humans and companion animals are advantageously treated herein. As used herein, “companion animal” means a domestic animal. Preferably, “companion animal” means a dog, cat, rabbit, ferret, horse, cow, or the like. More preferably, “companion animal” means a dog or cat.

The glucose anti-metabolite components which are useful herein include 2-deoxy-D-glucose, 5-thio-D-glucose, 3-O-methylglucose, anhydrosugars including 1,5-anhydro-D-glucitol, 2,5-anhydro-D-glucitol, and 2,5-anhydro-D-mannitol, and mannoheptulose. Mannoheptulose is preferred for use herein. Advantageously, mannoheptulose or any other component may be present in the recited compositions as a component of plant matter such as avocado extract, avocado meal, or other enriched source of mannoheptulose. Non-limiting examples of enriched sources of mannoheptulose are alfalfa, fig, or primrose. The plant matter may include the fruit, seed (or pit), branches, leaves, or any other portion of the relevant plant or combination thereof.

Avocado (also commonly referred to as alligator pear, aguacate, or palta) contains unusually enriched sources of mannoheptulose, as well as related sugars and other carbohydrates. Avocado is a sub-tropical evergreen tree fruit, growing most successfully in areas of California, Florida, Hawaii, Guatemala, Mexico, the West Indies, South Africa, and Asia.

Species of avocado include, for example, Persea Americana and Persea nubigena, including all cultivars within these illustrative species. Cultivars may include ‘Anaheim,’ ‘Bacon,’ ‘Creamhart,’ ‘Duke,’ ‘Fuerte,’ ‘Ganter,’ ‘Gwen,’ ‘Hass,’ ‘Jim,’ ‘Lula,’ ‘Lyon,’ ‘Mexicola,’ ‘Mexicola Grande,’ ‘Murrieta Green,’ ‘Nabal,’ ‘Pinkerton,’ ‘Queen,’ ‘Puebla,’ ‘Reed,’ ‘Rincon,’ ‘Ryan,’ ‘Spinks,’ ‘Topa Topa,’ ‘Whitsell,’ ‘Wurtz,’ and ‘Zutano.’ The fruit of the avocado is particularly preferred for use herein, which may contain the pit or wherein the pit is removed or at least partially removed. Fruit from Persea Americana is particularly preferred for use herein, as well as fruit from cultivars which produce larger fruits (e.g., about 12 ounces or more when the fruit is mature), such as Anaheim, Creamhart, Fuerte, Hass, Lula, Lyon, Murrieta Green, Nabal, Queen, Puebla, Reed, Ryan, and Spinks.

Plant matter from alfalfa, fig, or primrose are also reported to provide relatively high levels of mannoheptulose. Alfalfa is also referred to as Medicago sativa. Fig, or Ficus carica (including Cluster fig or Sycamore fig, for example) may also be used, as well as primrose or Primula officinalis.

It has been discovered that particular levels of a component selected from 2-deoxy-D-glucose; 5-thio-D-glucose; 3-O-methylglucose; 1,5-anhydro-D-glucitol; 2,5-anhydro-D-glucitol; 2,5-anhydro-D-mannitol; mannoheptulose; and mixtures thereof, are useful herein. In particular, it has been found that relatively low levels, as well as relatively high doses of the component, while useful, may provide less than optimal efficacy for desired purposes. Dosage will depend upon the glucose anti-metabolite component used and will vary depending upon the size and condition of the mammal to which the glucose anti-metabolite is to be administered. Dosage in the range of 0.0001 or 0.001 grams/kg to about 1 g/kg, per kilogram of body weight of the mammal, is beneficial. Dosage at the lower range would be appropriate when using 2-deoxy-D-glucose in large mammals. Higher dosage, particularly of compounds such as 5-thio-D-glucose or mannitol would be readily tolerated. In an embodiment, the dosage of the component provided to a mammal on a daily basis may be from about 1, 2 or 5 mg/kg to about 15, 20, 50, 100, 150 or 200 mg/kg wherein “mg” refers to the level of the component and “kg” refers to kilograms of body weight of the mammal. In an embodiment, the dosage to the mammal, on a daily basis, may be from about 1 mg/kg to about 15 mg/kg, from about 2 mg/kg to about 10 mg/kg, or from about 2 mg/kg to about 5 mg/kg. In certain embodiments, this may translate to compositions comprising less than about 5%, or less than about 2%, or from about 0.0001% to about 0.5% of the component, all by weight of the composition. The level of component may be determined by one of ordinary skill in the art based on a variety of factors, for example, the form of the composition (e.g., whether a dry composition, semi-moist composition, wet composition, or supplement, or any other form or mixture thereof). The ordinarily skilled artisan will be able to utilize the preferred dosage and determine the optimal level of component within a given composition.

Similarly, wherein an extract or meal of plant matter is utilized in the compositions herein, optimal levels of extract or meal may be dependent upon level of efficacious component within such extract or meal. Optimal extracts and/or meals have been found herein which comprise from about 0.5% to about 99% of the glucose anti-metabolite component, alternatively from about 0.5% to about 75% of the glucose anti-metabolite component, alternatively from about 0.5% to about 50% of the glucose anti-metabolite component, alternatively, from about 0.5% to about 25% of the glucose anti-metabolite component, all by weight of the extract or meal. Optimal extracts and/or meals have been found herein in which the glucose anti-metabolite component may be from about 0.5, 1, 2, 5, or 10% to about 15, 25, 50 or 75% by weight of the extract and/or meal.

The present invention is directed to a composition that is intended for ingestion by a mammal. Compositions include foods intended to supply necessary dietary requirements, as well as treats (e.g., biscuits) or other food supplements. Optionally, the composition herein may be a dry composition (for example, kibble), semi-moist composition, wet composition, or any mixture thereof. Alternatively or additionally, the composition is a supplement, such as a gravy, drinking water, yoghurt, powder, suspension, chew, treat (e.g., biscuits) or any other delivery form.

Moreover, in one embodiment the composition is nutritionally balanced. As used herein, the term “nutritionally balanced,” with reference to the composition, means that the composition has known required nutrients to sustain life in proper amounts and proportion based on recommendations of recognized authorities in the field of nutrition.

The compositions used herein may optionally comprise one or more further components. Other components are beneficial for inclusion in the compositions used herein, but are optional for purposes of the invention. In one embodiment, the compositions may comprise, on a dry matter basis, from about 10% to about 90% crude protein, alternatively from about 20% to about 50% crude protein, alternatively from about 20% to about 40% crude protein, by weight of the composition, or alternatively from about 20% to about 35% crude protein, by weight of the composition. The crude protein material may comprise vegetable-based proteins such as soybean, cereals (corn, wheat, etc), cottonseed, and peanut, or animal-based proteins such as casein, albumin, and meat protein. Non-limiting examples of meat protein useful herein include a protein source selected from the group consisting of beef, pork, lamb, poultry, fish and mixtures thereof.

Furthermore, the compositions may comprise, on a dry matter basis, from about 5% to about 40% fat, alternatively from about 10% to about 35% fat, by weight of the composition.

The compositions of the present invention may further comprise a source of carbohydrate. Grains or cereals such as rice, corn, milo, sorghum, barley, wheat, and the like are illustrative sources.

The compositions may also contain other materials such as, but not limited to, dried whey and other dairy by-products, beet pulp, cellulose, fiber, fish oil, flax, vitamins, minerals, flavors, antioxidants, and taurine.

### Optional Processes for Preparing the Compositions of the Present Invention

The compositions may be prepared by any of a variety of processes including, but not limited to, optional processes described herein. Disclosed herein are optional processes for preparing the present inventive compositions. The ordinarily skilled artisan will understand, however, that the compositions are not limited by the following described processes.

A process for preparing the present compositions may comprise:
(a) providing plant matter selected from the group consisting of avocado, alfalfa, fig, primrose, and mixtures thereof;
(b) optionally freeze drying plant matter to remove the aqueous phase to provide a meal;
(c) optionally, combining the plant matter with an aqueous solution and optionally with an enzyme, further optionally with heating, to provide a digested plant mixture;
(d) optionally separating any fractions present in the digested plant mixture, if any, to provide a carbohydrate extract;
(e) concentrating the digested plant mixture to enhance the concentration of carbohydrate therein; and
(f) combining the digested plant mixture with one or more composition components.

The plant matter provided in the optional processes may be avocado, alfalfa, fig, primrose, and mixtures thereof. The plant matter may be any portion or whole of the plant, such as the leaves, fruit, seed or pit, particularly at least those portions of the plant that contain elevated levels of carbohydrate such as 2-deoxy-D-glucose, 5-thio-D-glucose, 3-O-methylglucose, 1,5-anhydro-D-glucitol, 2,5-anhydro-D-glucitol, 2,5-anhydro-D-mannitol, or mannoheptulose. In one optional process herein, the avocado is provided, and the process may commence with whole avocado fruit, including the pit or devoid (or partially devoid) of the pit. If the plant matter which is provided contains a pit, or partial pit, the pit or portion thereof may be optionally removed prior to further processing. Alfalfa, fig, or primrose may be similarly processed.

In one optional process, production of a digested plant mixture comprises combination of the plant matter with an aqueous solution, such as water, to assist with maceration of the plant into manageable constituents. Optionally but preferably, an enzyme having cellulose or pectin activity, or any combination thereof (such as a cellulase, hemicellulase, or pectinase) is included to assist with such maceration, including to assist with dissolution and release of carbohydrates via cell wall disruption. The utility of such an enzymatic treatment may be enhanced through heating during such maceration, such as from above ambient temperature to about 120° C., or to about 100° C., or from about 60° C. to about 120° C., or from about 60° C. to about 100° C. Agitation is further preferably utilized, typically for up to about 24 hours, but dependent upon the batch under processing. In one embodiment, the pH is controlled such to preserve enzyme activity, often in the range of pH from about 4 to about 6, preferably in the range of pH from about 5 to about 6. As such, depending upon such factors as ripeness of plant matter, quality of process aqueous solution (such as water added for process, for example), and the like, amounts of acid or base may be desirable as will be appreciated by one of ordinary skill in the art.

Optionally, to assist with deactivation of the enzymes present, heating may be increased at the time of, or after, initial heating and agitation to form the digested plant mixture. Water is optionally heated to processing temperatures prior to the addition of the plant matter. Heat may be applied by a jacketed tank where low pressure steam is utilized.

The digested plant mixture may result in fractions which may be separated in accordance with common techniques. For example, fractions present in the digested plant mixture may be separated by filtration to provide the carbohydrate extract as the resulting filtrate, with the filter cake being discarded. Other methods may include, but not be limited to, gravimetric, centrifugal, other filtrations, or combinations thereof.

The carbohydrate extract may then be concentrated, optionally utilizing at least one concentration method selected from the group consisting of heating, vacuum drying, evaporation, refractance window drying, freeze drying, spray drying, any other useful technique, or any combination of the foregoing. In one embodiment, at least one technique such as refractance window drying is used.

Once concentrated, the carbohydrate extract may be utilized in the compositions of the present invention. In one embodiment herein, the present processes result in preferred yields of mannoheptulose or other carbohydrate, or carbohydrate extract, based on the starting mass of the plant matter (e.g., avocado). In one embodiment, the yield of mannoheptulose present in the carbohydrate extract or meal subsequent to concentration is less than about 20%, or from about 0.1% to about 10%, or from about 1% to about 7%, based on the starting mass of the plant matter. In another embodiment, the yield of the carbohydrate extract subsequent to concentration is less than about 30%, or from about 5% to about 25%, or from about 8% to about 20%, based on the starting mass of the plant matter. Of course, even higher yields may be desirable, and lower yields may also be acceptable.

The following non-limiting illustrations exemplify the various glucose anti-metabolites of the present invention:

### Decreased Utilization of Glucose as Energy Source by 2-Deoxy-D-Glucose:

To mimic the effects of caloric restriction, glucose anti-metabolites are provided over an extended time period. Previous studies show that 2-deoxy-D-glucose should not be administered in high doses, since significant untoward side effects and toxicity have been observed. However, studies in rodents (Lane et al., J. Anti-Aging Med. 1 (4): 327-337 (1998)) have shown that long-term disruption of glucose metabolism using a lower dose of 2-deoxy-D-glucose can mimic some of the major metabolic hallmarks of caloric restriction, enhanced longevity, including reduced body temperature, weight loss, and lower fasting insulin levels.

In light of the above potential physiologic benefits of caloric restriction weighed against the negative aspects of metabolic inhibition by 2-deoxy-D-glucose, alternatives which act as anti-metabolites of glucose without the potentially harmful side effects are preferred for purposes of practicing the invention.

### Decrease of Availability of Glucose to Cells by 5-Thio-D-Glucose:

5-Thioglucose, an analog of glucose, has (in vivo) more pronounced effects than 2-deoxy-D-glucose. The compound is believed to act mainly by inhibiting glucose uptake by the cells. The majority of 5-thioglucose (97%) injected into a rat has been found excreted unchanged in urine (Hoffman et al., Biochemistry 7, pp. 4479-4483 (1968)). 5-Thioglucose is remarkably non-toxic; LD₅₀ was measured to be 14 g/kg, by injection, in rats (Chen et al., Arch. Biochem. Biophys., 169, pp. 392-396 (1975)).

Since 5-Thioglucose seems to be excreted unchanged in urine, this compound presents certain advantages for chronic administration over 2-deoxy-D-glucose. Since 5-thioglucose inhibits glucose uptake, appropriate dosing can result in benefits associated with caloric restriction, including enhanced longevity.

### Effects of 3-O-Methylglucose:

This analog of glucose, in contrast with 2-deoxy-D-glucose, is not metabolized (Jay et al., J. Neurochem. 55, pp. 989-1000 (1990)) and, thus, may provide certain advantages for use in chronic administration. In the context of this invention, 3-O-methylglucose can prevent utilization of glucose as an energy source as demonstrated by response to its administration in rats. The responses were about seven times weaker than those to 2-deoxyglucose.

### Effects of Anhydrosugars: 1,5-Anhydro-D-Glucitol (Polygalitrol):

This compound is a non-reducing analog of glucose and is enzymatically converted to 1,5-anhydro-D-glucitol-6-phosphate, albeit the conversion is less efficient than that of 2-deoxy-glucose (Sols et al., J. Biol. Chem., 210, pp. 581-595 (1954). 1,5-anhydro-D-glucitol-6-phosphate is an allosteric (non-competitive) inhibitor of hexokinase, which catalyzes the first regulatory step of glycolysis (Crane et al., J. Biol. Chem., 210, pp. 597-696 (1954)). Furthermore, 1,5-anhydro-D-glucitol-6-phosphate is a non-reducing analog and cannot be a substrate for the next step of glycolysis catalyzed by glucose-6-phosphate isomerase. Consequently, this analog could accumulate in cells and act as a very effective metabolic block to glucose utilization. Another advantage relating to its non-reducing character is that this compound cannot be incorporated into glycolipids, glycoproteins, and glycogen. Thus, its effects are specific to glycolysis and would not be expected to affect other metabolic processes or exert toxicity of some glucose anti-metabolites previously discussed.

Interestingly, this compound (or its phosphate) has been found in the human body. It was found to be present in cerebrospinal fluid of patients who had occasional high blood glucose (from diabetes and diseases of the kidney) in large enough concentrations to be detected in tests performed in normal clinical settings.

### Use of 2,5-Anhydro-D-Mannitol and 2,5-Anhydro-D-Glucitol:

These compounds are non-reducing analogs of fructose. Fructose is an important component of food and fructose phosphates and diphosphate are intermediate products of glycolysis. Nevertheless, inhibition of metabolic events involving fructose and its phosphates by anhydrosugar analogs is difficult. Alpha and beta anomers of fructose, which spontaneously inter-convert, correspond to different anhydrosugars, to 2,5-anhydro-D-glucitol and 2,5-anhydro-D-mannitol, respectively. Thus, only a few of the enzymatic conversions can be inhibited by a single compound. The 2,5-Anhydro-D-mannitol has been investigated in some detail. That compound is taken up by cells and converted into 2,5-anhydro-D-mannitol-1-phosphate. That phosphate is an analog of fructose-1-phosphate, but cannot be cleaved by the aldolase and, thus, the utilization of both glucose and fructose by cells is blocked. The 2,5-Anhydro-D-mannitol had been found to interfere in glucose formation and utilization in isolated rat hepatocytes (Riquelme et al., Proc. Natl. Acad. Sci. USA, 80, pp. 431-435 (1983)).

### Decrease of Glucose Utilization as Energy Source by Ketoses:

Mannoheptulose is present in reasonable amounts in some foods (e.g., avocados may contain up to 5% of mannoheptulose, by wet weight) and can be classified as a “generally recognized as safe” substance for human consumption. In studies of metabolism, doses of 10 grams of mannoheptulose were safely administered to humans orally. About 5% of the mannoheptulose ingested was reported to appear in urine after oral administration. The fate of the injected mannoheptulose has previously been investigated in rats: 66% was excreted unchanged, 29% was metabolized and, a day after the injection, 5% remained in the body (Simon et al., Arch. Biochem. Biophys, 69, pp. 592-601 (1957)).

The availability of glucose to cells can also be decreased using other dietary supplements than those specifically identified herein which have similar effect on metabolism of glucose that can result in an inhibition of glucose processing.

The methods of the invention may be practiced by administering a compound described herein orally or parenterally, though oral administration would be preferred. When lowering of tissue metabolism is desired, as an adjunct to treatment of trauma, the compounds may be administered intravenously.

In addition to the effects of glucose anti-metabolites on insulin and related metabolism in dogs, mice fed a diet containing, for example, mannoheptulose, also exhibit reduced plasma insulin levels and slightly reduced body weight. Both of these endpoints are closely related to altered glucose and/or carbohydrate metabolism, similar to that elicited by dietary caloric restriction. Even more important from a fundamental metabolic standpoint, fruit flies and/or nematodes fed mannoheptulose exhibit lifespan extension of nearly 50%, an effect comparable to that exerted by caloric restriction in a number of animal species.

### EXAMPLES

The following examples are provided to illustrate the invention and are not intended to limit the scope thereof in any manner.

### Example 1

Avocado extract containing enhanced levels of mannoheptulose is prepared in accordance with the following optional process, and utilized in compositions of the present invention:

Whole avocado fruit (about 900 kilograms) is provided. The fruit is split and the pits are removed, either partially or wholly, providing about 225 kilograms of pitted avocado halves. The raw avocado is charged to a disintegrator, whereupon some agitation, water (about 3000 kilograms) and CELLUBRIX (commercially available from Novozymes A/S) (about 1 liter) is further charged. The mixture is further agitated and concurrently heated to about 66° C. Upon completion of the charge, further CELLUBRIX (about 1 liter) is added, and the entire mixture is held under agitation for about 12 hours at a controlled pH of about 5.5. The temperature is then further increased to about 80° C. and then held for at least about 2 hours. The resulting digested plant mixture is then filtered at 80° C. to provide the carbohydrate extract as the filtrate. The carbohydrate extract is then evaporated in a simplified recirculation system at 80° C., under vacuum, to provide the carbohydrate extract having from about 10% to about 20% solids and a pH of about 5.5. The extract is then further concentrated using a refractance window dryer to provide about 100 kilograms of the extract as a crystalline or powder (a yield of about 11% carbohydrate extract, based on the starting mass of the whole avocado fruit, which is analyzed as a yield from about 0.25% to about 4.5% mannoheptulose, based on the starting mass of the whole avocado fruit). It should be noted the amount of mannoheptulose found in avocados varies with the particular strain and state of ripeness of the fruit. The extract may be used in the compositions of the present invention.

### Example 2

Table 1 illustrates two kibble compositions having the following components at the approximate indicated amounts are prepared using methods which are standard in the art, including extrusion, and are fed to dogs and/or cats as a daily feed:

TABLE 1

| | Example 2A | Example 2B |
|---|---|---|
| | (Component Amount | (Component Amount |
| | indicated as | indicated as |
| Component | Wt %) | Wt %) |
| Extract of Avocado* | 0.02 | 0.01 |
| Chicken, Chicken By- | 44 | 47 |
| product Meal, Fish | | |
| Meal, and Egg | | |
| Chicken Fat | 8 | 6 |
| Beet Pulp | 2 | 3 |
| Salts | 2.5 | 2 |
| Vitamins and Minerals** | 1 | 1 |
| Minors*** | 3.5 | 4 |
| Grains | Remainder | Remainder |
| (corn, sorghum, barley, | | |
| rice, wheat) | | |

*Avocado may be substituted with other plant matter having enhanced mannoheptulose content. The incorporation of a mannoheptulose source likely replaces a similar amount of a grain source in the composition.
**Vitamins and Minerals may include: Vitamin E, beta-carotene, Vitamin A, Ascorbic Acid, Calcium Pantothenate, Biotin, Vitamin B₁₂, Vitamin B₁, Niacin, Vitamin B₂, Vitamin B₆, Vitamin D₃, Vitamin D₂, Folic Acid, Choline Chloride, Inositol, Calcium Carbonate, Dicalcium Phosphate, Potassium Chloride, Sodium Chloride, Zinc Oxide, Manganese Sulfate, Copper Sulfate, Manganous Oxide, Ferrous Sulfate, Potassium Iodide, Cobalt Carbonate.
***Minors may include: Fish oil, flax seed, flax meal, cellulose, flavors, antioxidants, taurine, yeast, carnitine, chondroitin sulfate, glucosamine, lutein, rosemary extract.

### Example 3

Table 2 illustrates a beef-flavor gravy composition is prepared by combining the following components in a conventional manner:

TABLE 2

| Component | Wt % |
|---|---|
| Mannoheptulose* | 0.14 |
| Chicken Fat | 3.0 |
| Spray-Dried Beef Particles and Broth | 3.0 |
| Xanthan Gum | 0.5 |
| Flax Seed | 0.2 |
| Vegetables | 0.2 |
| Vitamins** | 0.06 |
| Minerals** | 0.04 |
| Phosphoric Acid | 0.95 |
| Beef Flavor | 0.1 |
| Water | Remainder |

*Mannoheptulose may be substituted with another component as described herein. The incorporation of a mannoheptulose source likely replaces a similar amount of water in the composition.
**Vitamins and Minerals may include: Vitamin E, beta-carotene, Vitamin A, Ascorbic Acid, Calcium Pantothenate, Biotin, Vitamin B₁₂, Vitamin B₁, Niacin, Vitamin B₂, Vitamin B₆, Vitamin D₃, Vitamin D₂, Folic Acid, Choline Chloride, Inositol, Calcium Carbonate, Dicalcium Phosphate, Potassium Chloride, Sodium Chloride, Zinc Oxide, Manganese Sulfate, Copper Sulfate, Manganous Oxide, Ferrous Sulfate, Potassium Iodide, Cobalt Carbonate.

One fluid ounce of the gravy composition is mixed with one-half cup of a standard composition daily prior to feeding to a mammal. Amounts of the gravy composition are determined as desired by the guardian of the mammal.

### Example 4

### Preparation of Mannoheptulose-Containing Avocado Meal

Fresh avocados (Lula variety) were obtained from Fresh King Incorporated (Homestead, Fla.). The avocados were manually split open and the pits were removed and discarded. The remaining skin and pulp were ground through a Hobart Commercial Food Preparation machine (Serial No. 11-10410235) using a 12¼ sieve. The ground avocado was then transferred to an Edwards Freeze Drier (Super Modulyo Model, Crawely, Sussex, England). The freeze drier was set at −20° C. for the first 24 hours, −5° C. for the following 24 hours and 5° C. for the final 72 hours. Upon removal from the freeze drier, the meal was ground to a powder using a Straub Grinding Mill (model 4E, Philadelphia, Pa.). The avocado meal was analyzed and found to contain about 10.35% mannoheptulose, by weight of the meal. It should be noted that the amount of mannoheptulose found in avocados varies with the particular strain and state of ripeness, some avocados having little or no mannoheptulose.

### Example 5

### Administration of Mannoheptulose-containing Avocado Meal to Beagle Dogs

The use of mannoheptulose for purposes of maintaining and/or attenuating a decline in the health, functional activity and/or biomarkers of longevity as a result of mimicking caloric restriction was tested in beagle dogs through measurement of insulin reduction. As has been discussed, and is now widely accepted in the art, insulin reduction is a hallmark of caloric restriction and therefore a suitable indicator and/or biomarker.

A total of 12 beagles were utilized for the study and were fed a standard commercial composition (Eukanuba Senior Maintenance Formula) through the study period. Fasting blood samples were drawn 7, 6, 4, and 2 days prior to administration of mannoheptulose. The mannoheptulose was delivered to the dogs in the form of a freeze-dried avocado meal containing from about 10% to about 12% mannoheptulose, by weight of the meal. This preparation was adjusted to provide mannoheptulose doses of 2, 20, and 200 mg/kg body weight (MH-2, MH-20, MH-200, respectively). Fasting blood samples were collected 1, 3, 5, and 7 days after initiation of the administration of mannoheptulose.

Insulin levels were lowered by up to 35% in dogs which had received the avocado meal when compared to those dogs on similar compositions which had not received avocado meal with their compositions. Those changes were similar to the decreases found in animals on caloric restricted diets. In contrast, plasma glucose concentrations of dogs fed the same standard composition which did not contain the avocado meal did not show such effects.

Without intending to be limited by theory, the mechanism by which insulin is reduced relates to the fact that glucose must be metabolized by the pancreas to stimulate insulin secretion (German et al., Proc. Nat. Acad. Sci., 90, 1781-1785 (1993)). Mannoheptulose is thought to inhibit hexokinase, the initial enzyme involved in glucose metabolism. Therefore, reduced insulin levels indicate that mannoheptulose has indeed inhibited glucose metabolism, thereby mimicking caloric restriction. This effect on hexokinase by mannoheptulose would indicate use of mannoheptulose directed at inhibition of tumor growth as an alternative to administration of 2-deoxy-D-glucose. See Board et al., Cancer Res., 55(15): 3278-3285 (1995). Mannoheptulose would present a safe alternative to 2-deoxy-D-glucose, since it would avoid some untoward effects seen when 2-deoxy-D-glucose is administered on a long-term basis.

### Example 6

### Once Daily Administration of Mannoheptulose in a Nutritionally-Balanced Composition Fed to Adult Labrador Retriever Dogs

The pharmacokinetics of mannoheptulose can be determined in six adult, male Labrador Retriever dogs fed a nutritionally-balanced composition providing mannoheptulose at levels of 0, 1 or 2 mg/kg of body weight of the dog. Mannoheptulose is provided as an enriched source of avocado extract in the 1 and 2 mg/kg diets. The mean age of the dogs is 4.2 years and the age ranges from 3.3 to 6.1 years. The average body weight of all dogs is 33 kg and the body weight ranges from 28 to 36 kg. Dogs are adapted for 14 days to a nutritionally-balanced control composition (Eukanuba Senior Maintenance Formula) containing no mannoheptulose, avocado extract or avocado meal (0 mg/kg mannoheptulose). The two compositions containing mannoheptulose are the nutritionally-balanced control composition formulated with avocado extract to provide a mannoheptulose dose of 1 or 2 mg/kg of body weight when fed to a dog. The amount of composition offered to the dogs is based on feeding guidelines for the control composition and the target weight range and body condition of the dogs. After 14 days, dogs are fed one of the three compositions for 9 days. On day 9, the dogs are fed their daily allotment of composition as a single meal at 0730. Dog 1 and dog 2 are fed the control composition containing 0 mg/kg mannoheptulose, dog 3 and dog 4 are fed the composition containing 1 mg/kg mannoheptulose, and dog 5 and dog 6 are fed the composition containing 2 mg/kg mannoheptulose. Pharmacokinetics of mannoheptulose following once daily administration of mannoheptulose in a nutritionally-balanced composition is determined by collecting serial blood samples (3 mL) from each dog on day 9 using a Vacutainer blood collection system and jugular venipuncture. Blood samples are collected at −30, 0, 30, 60, 90, 120, 240, 360, 480, 600, 720 and 1,440 minutes relative to each dog receiving their entire daily allotment of composition as a single meal. Plasma mannoheptulose concentrations are measured using high-performance liquid chromatography tandem mass spectrometry as described herein below.

A one-compartment model is used to calculate mannoheptulose pharmacokinetics based on plasma mannoheptulose levels following once daily oral administration of mannoheptulose in a nutritionally-balanced composition (P_{V(t)}). The model is: P_{V(t)}=dose/(a·BW)e^{-kt} where: a mannoheptulose pool size (dose/(enrichment at to)), BW=body weight, k=rate constant of elimination (In Eₜ−1n E₀)/−t, and t=time. Area under each plasma mannoheptulose curve is determined using a one-way, repeated measures analysis of variance (GraphPad Prism version 4.00 for Windows).

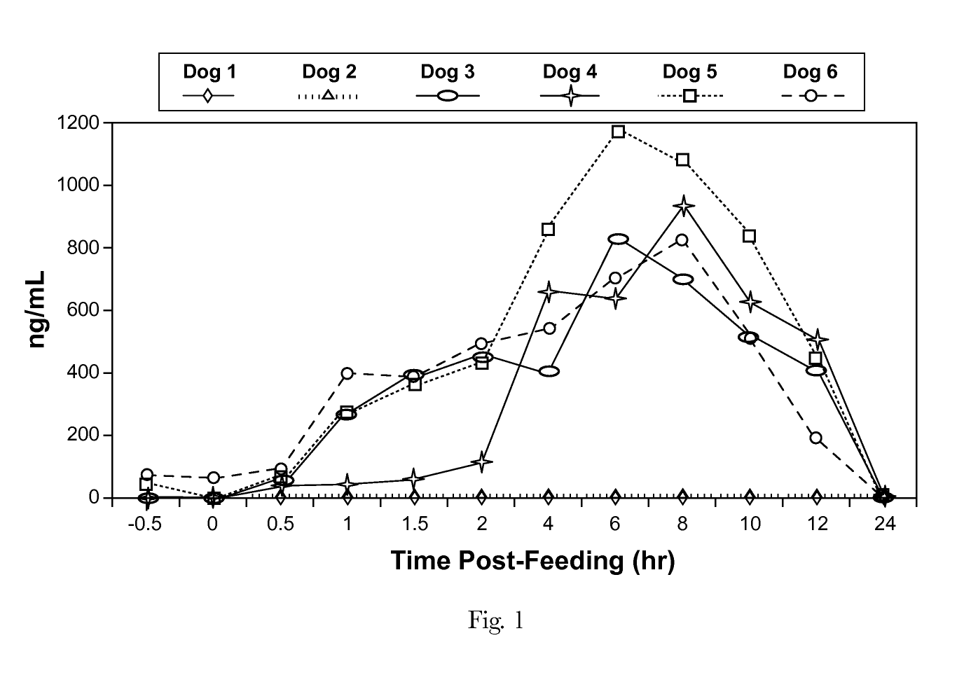

FIG. 1 is a graphical presentation of the serial concentrations of plasma mannoheptulose in adult Labrador Retrievers fed a single meal of a nutritionally-balanced composition containing mannoheptulose at a dose of 0 mg/kg (dogs 1 and 2), 1 mg/kg (dogs 3 and 4) or 2 mg/kg (dogs 5 and 6). Plasma mannoheptulose reaches peak concentrations in adult dogs between 6 and 8 hours after the consumption of a single meal of a composition containing mannoheptulose. Plasma mannoheptulose concentrations return to non-detectable levels by 24-hours after consumption of the single daily meal. Plasma mannoheptulose follows first order kinetics with the once daily oral administration of 1 or 2 mg/kg of mannoheptulose in a nutritionally-balanced composition. Mathematical modeling shows mannoheptulose has a half-life of 6.25 hours and a turnover time of 9.0 hours following once daily oral administration of mannoheptulose (2 mg/kg) in a nutritionally-balanced composition. Plasma mannoheptulose levels respond to dietary mannoheptulose levels in a dose-dependent manner. Feeding a composition containing 2 mg/kg mannoheptulose results in higher plasma mannoheptulose concentrations compared with feeding compositions containing 0 and 1 mg/kg mannoheptulose. Mannoheptulose is not detected in the plasma of dogs consuming a composition containing 0 mg/kg mannoheptulose. Area under the curve is different for all three compositions and is dependent on the oral dose of mannoheptulose administered to the dog. There is no measurable area under the plasma mannoheptulose curve for dogs consuming a composition devoid of mannoheptulose compared with greater areas under the curve with compositions that provide 1 or 2 mg/kg of mannoheptulose per body weight of the dog.

### Example 7

### Twice Daily Administration of Mannoheptulose in a Nutritionally-Balanced Composition Fed to Older Labrador Retriever Dogs

The pharmacokinetics of mannoheptulose can be determined in ten adult, female Labrador Retriever dogs fed a nutritionally-balanced composition providing mannoheptulose at levels of 0 or 2 mg/kg of body weight of the dog. Mannoheptulose is provided as avocado extract in the 2 mg/kg diet. The mean age of the dogs is 7.1 years and the age ranges from 5.3 to 8.4 years. Dogs are age-matched across the two composition groups. The average body weight of all dogs is 29 kg and ranges from 25 to 35 kg. The 0 mg/kg composition is fed as a nutritionally-balanced control composition (Eukanuba Senior Maintenance Formula) and it contains no mannoheptulose, avocado extract or avocado meal. The 2 mg/kg composition is the nutritionally-balanced control composition formulated to contain avocado extract to provide mannoheptulose at a dose of 2 mg/kg of body weight of the dog. The amount of composition offered to the dogs is based on feeding guidelines for the control composition and the target weight range and body condition of the dogs. Dogs are fed one-half their daily allotment of composition at 0730 and the remaining half at 1330. Dogs 1, 2, 3, 4 and 5 are fed the composition containing 2 mg/kg mannoheptulose and dogs 6, 7, 8, 9 and 10 are fed the composition containing 0 mg/kg mannoheptulose. Pharmacokinetics of mannoheptulose following twice daily administration of mannoheptulose in a nutritionally-balanced composition is determined by collecting serial blood samples (3 mL) from each dog using a Vacutainer blood collection system and jugular venipuncture. Blood samples are collected at 0, 120, 240, 360, 480, 600, 720 and 1,440 minutes relative to each dog receiving their entire daily allotment of composition in two separate but equal meals. Plasma mannoheptulose concentrations are measured using high-performance liquid chromatography tandem mass spectrometry as described herein below.

A one-compartment model is used to calculate mannoheptulose pharmacokinetics based on plasma mannoheptulose levels following twice daily oral administration of mannoheptulose in a nutritionally-balanced composition (P_{V(t)}). The model is: P_{V(t)}=dose/(a·BW)e^{-kt} where: a=mannoheptulose pool size (dose/(enrichment at to)), BW=body weight, k=rate constant of elimination (In Eₜ−1n E₀)/−t, and t=time.

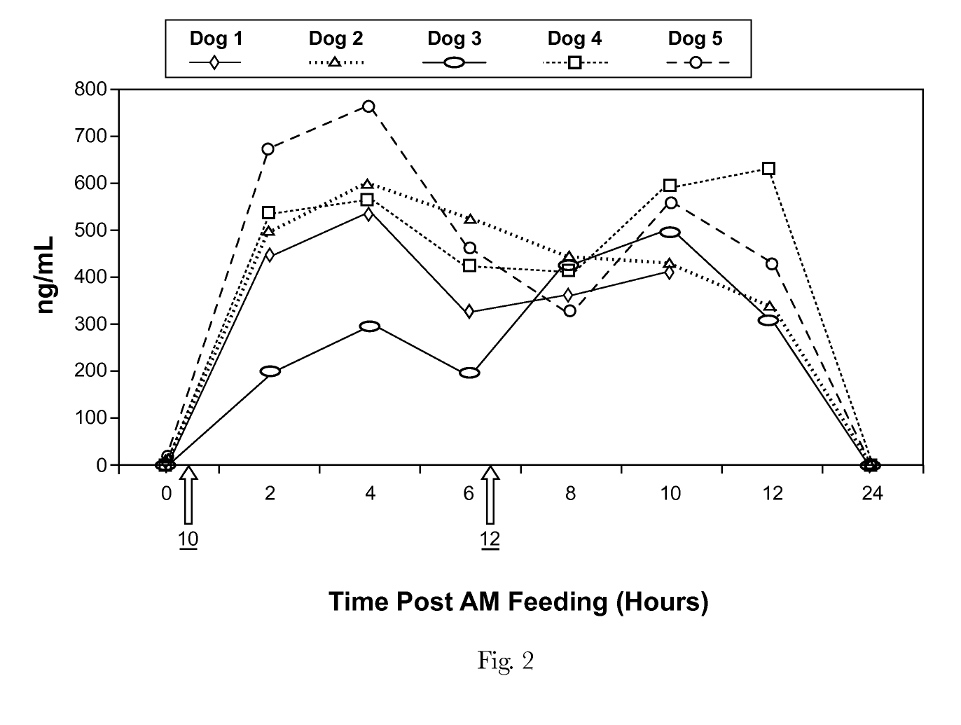

FIG. 2 is a graphical presentation of the serial concentrations of plasma mannoheptulose in adult Labrador Retrievers fed two equal meals of a nutritionally-balanced composition containing mannoheptulose at a dose of 2 mg/kg of body weight (dogs 1, 2, 3, 4 and 5). No detectable mannoheptulose is present in the plasma of dogs fed the nutritionally-balanced composition devoid of mannoheptulose (0 mg/kg). Plasma mannoheptulose levels rise from undetectable levels at time of initial feeding 10 to peak levels in 4 hours in dogs fed a nutritionally-balanced composition containing avocado extract to provide mannoheptulose at a dose of 2 mg/kg of body weight. A second peak in plasma mannoheptulose concentrations occurs 4 hours after feeding an afternoon meal 12 of the same composition containing mannoheptulose at a dose of 2 mg/kg of body weight. Plasma mannoheptulose concentrations return to undetectable levels by the following morning. Similar to once daily oral administration, plasma mannoheptulose follows first order kinetics with twice daily oral administration of mannoheptulose in a nutritionally-balanced composition that provides mannoheptulose at a level of 2 mg/kg of body weight. Mathematical modeling shows twice daily oral administration of mannoheptulose in a nutritionally-balanced composition results in a mannoheptulose half-life of 5.42 hours and a turnover time of 7.8 hours after the morning meal and a half-life of 5.63 hours and a turnover time of 3.90 hours after the afternoon meal.

### Example 8

### Long-Term Administration of Mannoheptulose in a Nutritionally-Balanced Composition Fed to a Cohort of Older Adult Labrador Retriever Dogs

A total of 39 older Labrador Retrievers are fed a nutritionally-balanced composition providing mannoheptulose at levels of 0 or 2 mg/kg of body weight of the dog. Average age of the dogs (12 neutered males, 27 spayed females) at the start of a 4-year study is 6.7 years with a range of 5.1 to 8.2 years of age for the youngest and oldest dog within the cohort, respectively. The 0 mg/kg composition is fed as a nutritionally-balanced control composition (Eukanuba Senior Maintenance Formula) and it contains no mannoheptulose, avocado extract or avocado meal. The 2 mg/kg composition is the nutritionally-balanced control composition formulated with avocado extract to provide mannoheptulose at a dose of 2 mg/kg body weight of the dog. The nutritionally-balanced composition containing 0 mg/kg mannoheptulose is referred to as Diet 1 within this Example. The nutritionally-balanced composition containing 2 mg/kg mannoheptulose is referred to as Diet 2 within this Example. The daily food allowance for each older dog is based on the amount of food required to maintain the target body weight and body condition of each dog as described herein below in the Animal Feeding Management Method. Older dogs are fed one-half their daily allotment of food at 0730 and 1430 each day. Consumption of the nutritionally-balanced compositions by older dogs during years 1, 2, 3 and 4 averages 436, 409, 392 and 385 g/day for dogs fed Diet 1 and 428, 389, 392 and 390 g/day for dogs fed Diet 2, respectively. Monthly, quarterly, biannually and/or annual measurements are used to assess the maintenance and/or attenuation in the decline of the quality of life of the mammal.

Table 3 shows the body weight at year 0 and year 4 of older dogs fed Diet 1 and Diet 2.

TABLE 3

| | | Diet 1 | | | Diet 2 | | |
|---|---|---|---|---|---|---|---|
| Older dogs | Year | Mean | Min | Max | Mean | Min | Max |
| Body weight, kg | 0 | 28.4 | 19.2 | 35.2 | 28.9 | 20.2 | 41.4 |
| | 4 | 30.7 | 22.4 | 39.4 | 31.5 | 24.3 | 40.0 |

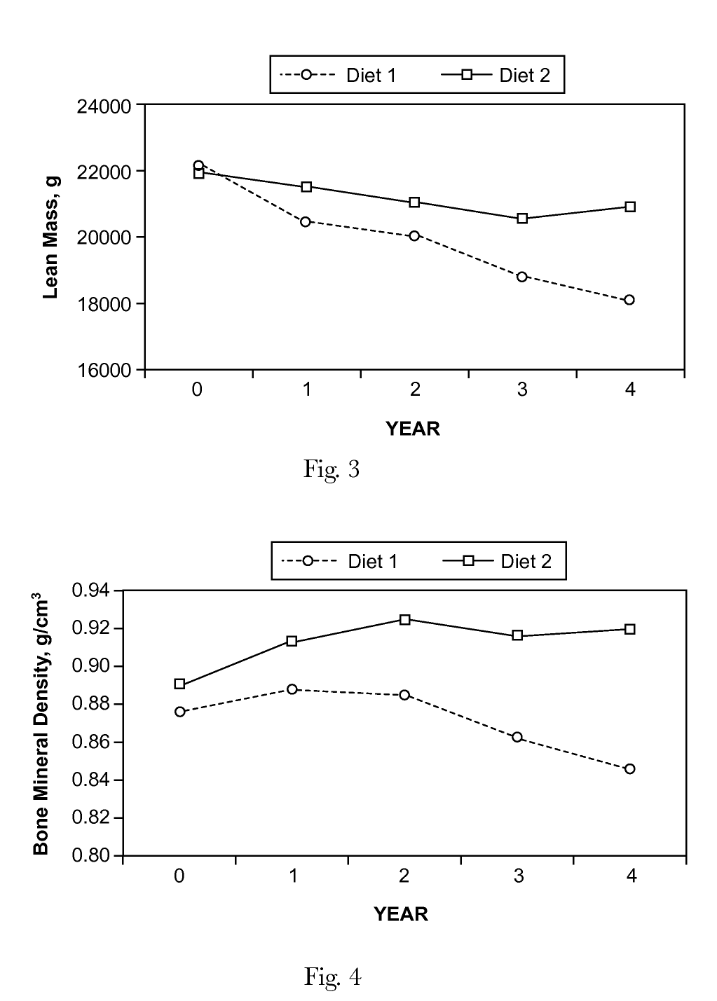

FIG. 3 is a graphical presentation of the average yearly lean body mass of older dogs over 4 years of feeding nutritionally-balanced compositions that provide mannoheptulose at levels of 0 mg/kg (Diet 1) or 2 mg/kg (Diet 2) of body weight of the dog. Lean body mass of individual dogs is measured annually by DEXA as described herein below. As older dogs increase in average age from 6.7 to 10.7 years, the amount of lean body mass does not change appreciably when consuming a nutritionally-balanced composition containing mannoheptulose at a level of 2 mg/kg of body weight. In contrast, older dogs consuming a nutritionally-balanced composition devoid of mannoheptulose steadily lose lean body mass over 4 years. Mannoheptulose provided as avocado extract in a nutritionally-balanced composition maintains and/or attenuates the decline of lean body mass of older dogs as they age.

FIG. 4 is a graphical presentation of the average yearly bone mineral density of older dogs over 4 years of feeding nutritionally-balanced compositions that provide mannoheptulose at levels of 0 mg/kg (Diet 1) or 2 mg/kg (Diet 2) of body weight of the dog. Bone mineral density of individual dogs is measured annually by DEXA as described herein below. As older dogs increase in average age from 6.7 to 10.7 years, maintenance and/or attenuation in the decline of bone mineral density is observed when consuming a nutritionally-balanced composition containing mannoheptulose at a level of 2 mg/kg of body weight. In contrast, a decline in bone mineral density is observed in older dogs consuming a nutritionally-balanced composition devoid of mannoheptulose beginning at year 2 with a steady decline thereafter. Mannoheptulose provided as avocado extract in a nutritionally-balanced composition maintains and/or attenuates a decline in bone mineral density of older dogs as they age.

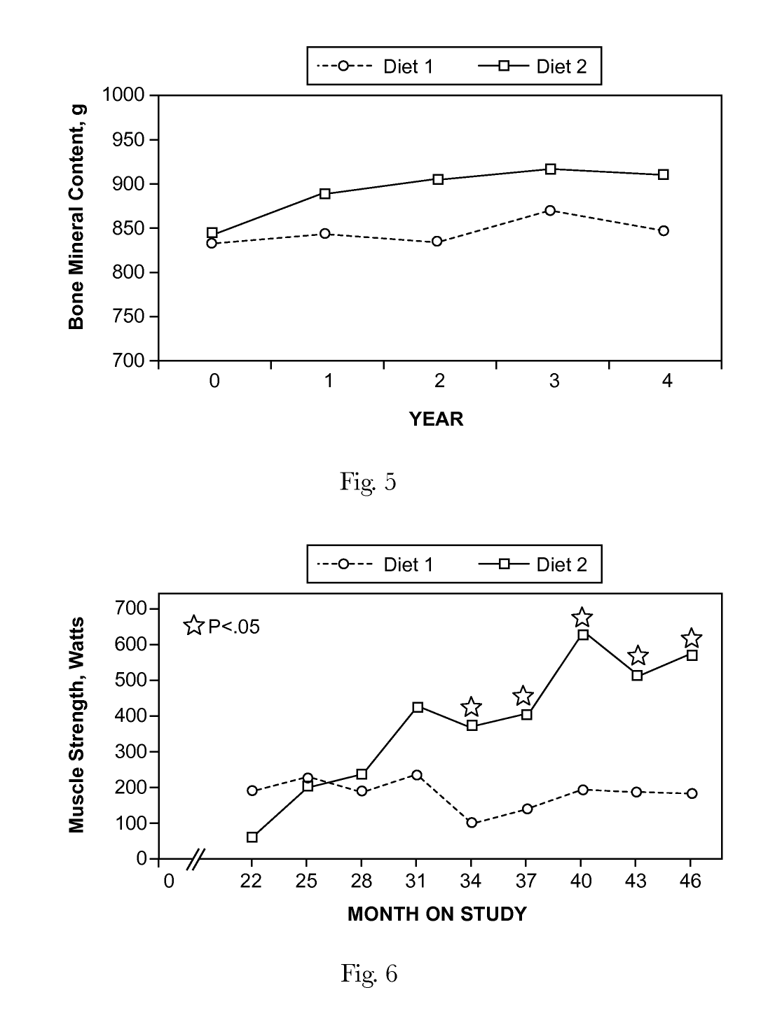

FIG. 5 is a graphical presentation of the average yearly bone mineral content of older dogs over 4 years of feeding nutritionally-balanced compositions that provide mannoheptulose at levels of 0 mg/kg (Diet 1) or 2 mg/kg (Diet 2) of body weight of the dog. Bone mineral content of individual dogs is measured annually by DEXA as described herein below. As older dogs increase in average age from 6.7 to 10.7 years, enhancement of bone mineral content is observed within the first year and bone mineral content continues to increase thereafter when consuming a nutritionally-balanced composition containing mannoheptulose at a level of 2 mg/kg of body weight. In contrast, older dogs consuming a nutritionally-balanced composition devoid of mannoheptulose show no appreciable change in bone mineral content over 4 years except for a transient increase in year 3 that returns to previous levels by year 4. Mannoheptulose provided as avocado extract in a nutritionally-balanced composition maintains or enhances bone mineral content of older dogs as they age.

FIG. 6 is a graphical presentation of the average muscle strength expressed as muscle power of older dogs during 4 years of feeding nutritionally-balanced compositions that provide mannoheptulose at levels of 0 mg/kg (Diet 1) or 2 mg/kg (Diet 2) of body weight of the dog. Muscle strength of individual dogs is determined monthly beginning at month 19 as described herein below. Data are pooled quarterly for analysis and reporting beginning with month 22. By month 31, muscle strength is higher in older dogs consuming a nutritionally-balanced composition containing mannoheptulose at a level of 2 mg/kg of body weight. Muscle strength continue to improve with long-term oral administration of mannoheptulose in a nutritionally-balanced composition. In contrast, muscle strength does not increase over time and remains constant for older dogs consuming a nutritionally-balanced composition devoid of mannoheptulose. Mannoheptulose provided as avocado extract in a nutritionally-balanced composition maintains, and/or enhances muscle strength of older dogs as they age.

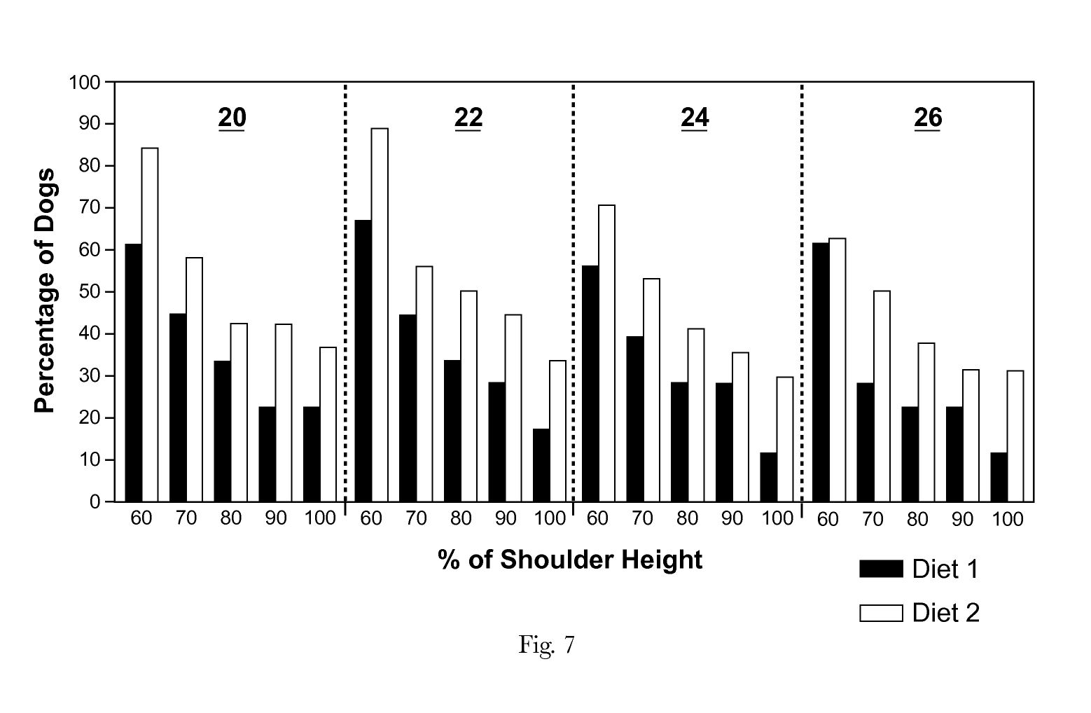

FIG. 7 is a graphical presentation of the percentage of older dogs successfully jumping over various heights relative to their individual shoulder height during four consecutive quarters of a 4 year period of feeding nutritionally-balanced compositions that provide mannoheptulose at levels of 0 mg/kg (Diet 1) or 2 mg/kg (Diet 2) of body weight of the dog. Jumping ability of individual dogs is determined quarterly as described herein below. The initial assessment (start of first quarter) is made at month 37 of the study and continues for one year. The four consecutive quarters are represented as reference numbers 20, 22, 24 and 26, respectively in FIG. 7.

Table 4 shows least-squares means for measured shoulder heights of older dogs fed Diet 1 and Diet 2 and the probability value of the pair-wise comparison between the two groups. Shoulder height of the individual dog is used herein below as the standard to assess individual jumping ability. The maximum height successfully jumped by an individual dog is expressed as a percentage of their individual shoulder height. A reported p-value greater than 0.10 indicates no significant difference in shoulder height for older dogs assigned to Diet 1 and Diet 2.

TABLE 4

| Older dogs | Diet 1 | Diet 2 | P-value |
|---|---|---|---|
| Shoulder height, cm | 21.6 | 21.9 | 0.494 |

Table 5 shows the probability value for the pair-wise comparison across all four quarters for the percentage of older dogs fed Diet 1 and Diet 2 that successfully jump a height relative to their individual shoulder height. The assessment of functional capacity is based on the ability of older dogs to successfully jump heights that range from 60 to 100% of their individual shoulder height. A reported p-value less than or equal to 0.10 indicates a statistically significant difference between Diet 1 and Diet 2 across all four test quarters for the percentage of dogs successfully jumping similar heights.

TABLE 5

| | Successful jumping height as a | | | | |
|---|---|---|---|---|---|
| | percentage of shoulder height, % | | | | |
| | 60 | 70 | 80 | 90 | 100 |
| P-value comparing Diet 1 vs. Diet 2 | .043 | .074 | .097 | .089 | .016 |

A greater percentage of dogs can successfully jump heights that are typically considered non-strenuous for normal, healthy dogs (60 or 70% of their shoulder height). As jumping height increases to 80, 90 or 100% of their shoulder height, a smaller percentage of older dogs can successfully jump these heights demonstrating a more demanding and physically challenging activity and/or test for older dogs. Across all four quarters, a greater percentage of older dogs are able to successfully jump all heights when consuming a nutritionally-balanced composition containing mannoheptulose at a level of 2 mg/kg of body weight as compared with dogs consuming a nutritionally-balanced composition devoid of mannoheptulose. Mannoheptulose provided as avocado extract in a nutritionally-balanced composition maintains and/or attenuates a decline in the jumping ability of older dogs as they age.

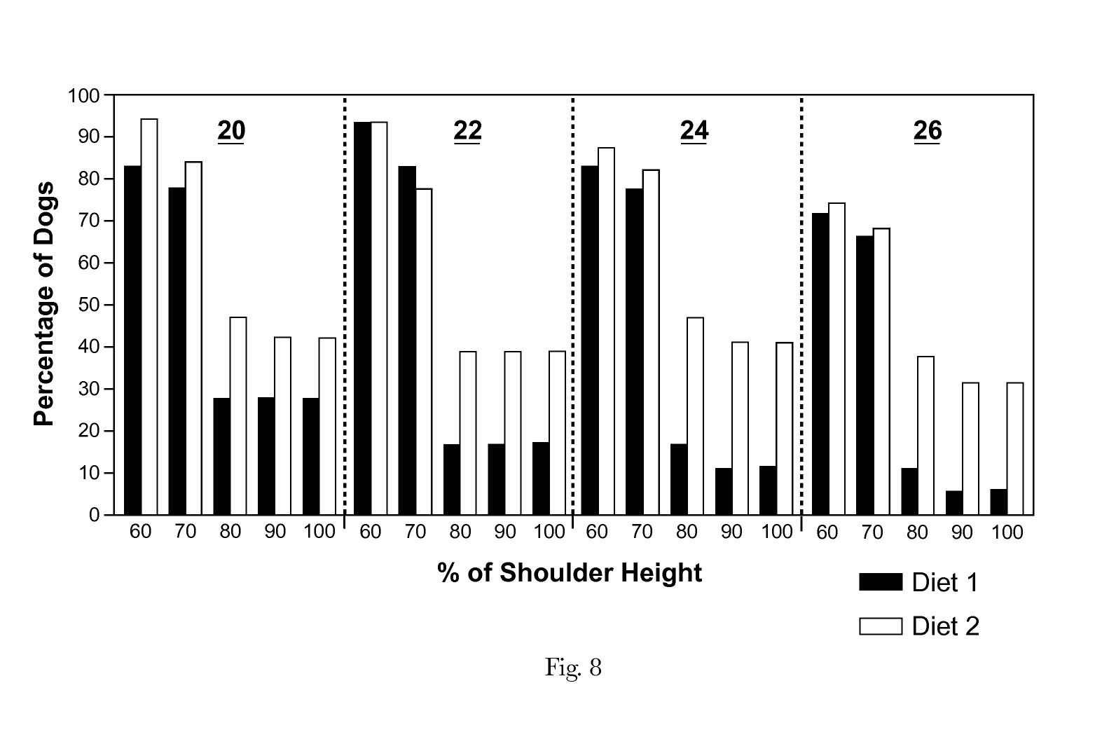

FIG. 8 is a graphical presentation of the percentage of older dogs successfully jumping onto table platforms of varying heights relative to their individual shoulder height during four consecutive quarters of a 4 year period of feeding nutritionally-balanced compositions that provide mannoheptulose at levels of 0 mg/kg (Diet 1) or 2 mg/kg (Diet 2) of body weight of the dog. Jumping ability of individual dogs is determined quarterly as described herein below. The initial assessment (start of first quarter) is made at month 37 of the study and continues for one year. The four consecutive quarters are represented as reference numbers 20, 22, 24 and 26, respectively, in FIG. 8.

Table 6 shows the probability value for the pair-wise comparison across all four quarters for the percentage of older dogs fed Diet 1 and Diet 2 that successfully jump onto table platforms of increasing height relative to their individual shoulder height. The assessment of functional capacity is based on the ability of dogs to successfully jump onto table platforms of differing heights that range from 60 to 100% of their individual shoulder height. A reported p-value less than or equal to 0.10 indicates a statistically significant difference between Diet 1 and Diet 2 across all four test quarters for the percentage of dogs successfully jumping onto table platforms of similar heights. A reported p-value that is greater than 0.10 indicates a similar jumping ability for both groups across all four quarters.

TABLE 6

| | Platform height as a percentage of | | | | |
|---|---|---|---|---|---|
| | shoulder height, % | | | | |
| | 60 | 70 | 80 | 90 | 100 |
| P-value comparing Diet 1 vs. Diet 2 | .402 | .074 | .001 | .002 | .002 |

A greater percentage of dogs can successfully jump onto platform heights that are typically considered non-strenuous for normal, healthy dogs (60 or 70% of their shoulder height). As the platform height increases to 80, 90 or 100% of their individual shoulder height, a smaller percentage of older dogs can successfully jump onto taller platforms demonstrating a more demanding and physically challenging activity and/or test for older dogs. Across all four quarters, a greater percentage of older dogs can successfully jump onto platforms that are 70, 80, 90 and 100% of their shoulder height when consuming a nutritionally-balanced composition containing mannoheptulose at a level of 2 mg/kg of body weight. The improved jumping success at the higher platform heights is maintained during all four testing quarters as compared with dogs fed a nutritionally-balanced composition devoid of mannoheptulose as their jumping success declined over time. Mannoheptulose provided as avocado extract in a nutritionally-balanced composition maintains and/or attenuates a decline in the jumping ability of older dogs as they age.

### Example 9

### Long-Term Administration of Mannoheptulose in a Nutritionally-Balanced Composition to a Cohort of Younger Adult Labrador Retriever Dogs

A total of 41 younger Labrador Retrievers are fed a nutritionally-balanced composition providing mannoheptulose at levels of 0 or 2 mg/kg of body weight of the dog. Average age of the dogs (12 neutered males, 29 spayed females) at the start of the 36-month feeding study is 4.0 years with a range of 2.0 to 6.1 years of age for the youngest and oldest dog within the cohort, respectively. The 0 mg/kg composition is fed as a nutritionally-balanced control composition (Eukanuba Senior Maintenance Formula) and it contains no mannoheptulose, avocado extract or avocado meal. The 2 mg/kg composition is the nutritionally-balanced control composition formulated with avocado extract to provide mannoheptulose at a dose of 2 mg/kg body weight of the dog. The nutritionally-balanced composition containing 0 mg/kg mannoheptulose is referred to as Diet 1 within this Example. The nutritionally-balanced composition containing 2 mg/kg mannoheptulose is referred to as Diet 2 within this Example. The daily food allowance for each younger dog is based on the amount of food required to maintain the target body weight and body condition of each dog as described herein below in the Animal Feeding Management Method. Younger dogs are fed one-half their daily allotment of food at 0730 and 1430 each day. Consumption of the nutritionally-balanced compositions by younger dogs during years 1, 2 and 3 averages 419, 354 and 384 g/day for dogs fed Diet 1 and 443, 373 and 402 g/day for dogs fed Diet 2, respectively. Monthly, quarterly, biannually and/or annual measurements are used to assess the maintenance and/or attenuation in the decline of the quality of life of the mammal.

Table 7 shows the body weight at year 0 and year 3 of younger dogs fed Diet 1 and Diet 2.

TABLE 7

| | | Diet 1 | | | Diet 2 | | |
|---|---|---|---|---|---|---|---|
| Younger dogs | Year | Mean | Min | Max | Mean | Min | Max |
| Body weight, kg | 0 | 28.7 | 19.9 | 39.7 | 29.0 | 22.8 | 36.6 |
| | 3 | 28.7 | 21.7 | 38.9 | 28.3 | 23.7 | 34.9 |

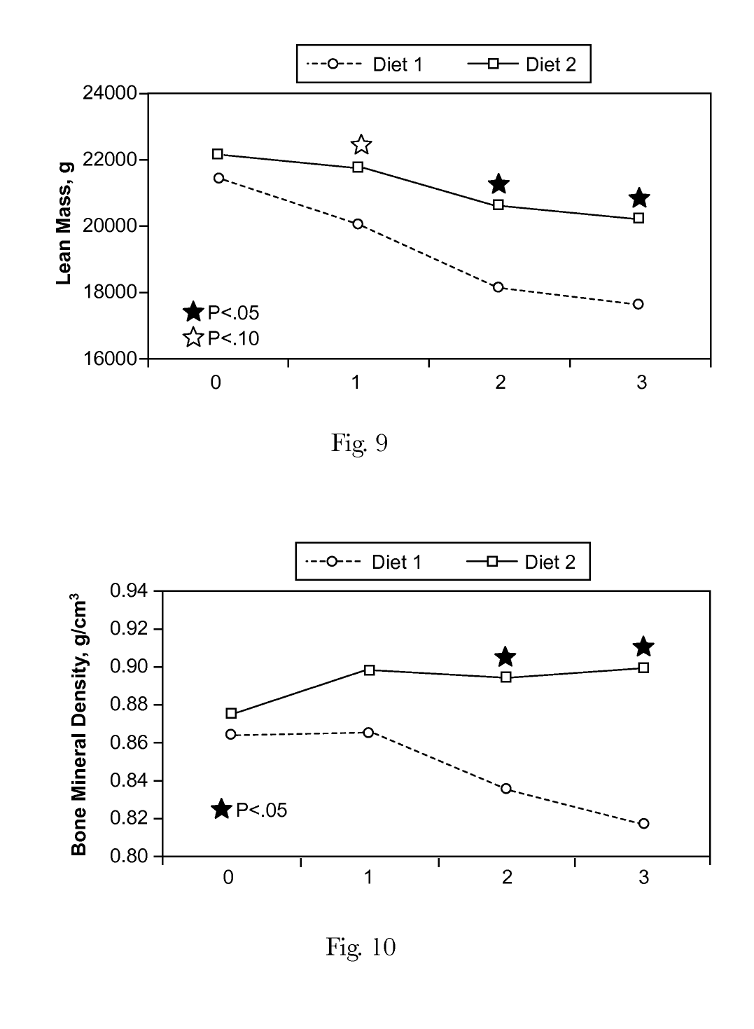

FIG. 9 is a graphical presentation of the average yearly lean body mass of younger dogs over 3 years of feeding nutritionally-balanced compositions that provide mannoheptulose at levels of 0 mg/kg (Diet 1) or 2 mg/kg (Diet 2) of body weight of the dog. Lean body mass of individual dogs is measured annually by DEXA as described herein below. As younger dogs increase in average age from 4.0 to 7.0 years, the amount of lean body mass does not change appreciably when consuming a nutritionally-balanced composition containing mannoheptulose at a level of 2 mg/kg of body weight. In contrast, younger dogs consuming a nutritionally-balanced composition devoid of mannoheptulose lose more lean body mass over 3 years. Mannoheptulose provided as avocado extract in a nutritionally-balanced compositions maintains and/or attenuates a decline in the lean body mass of younger dogs as they age.

FIG. 10 is a graphical presentation of the average yearly bone mineral density of younger dogs over 3 years of feeding nutritionally-balanced compositions that provide mannoheptulose at levels of mg/kg (Diet 1) or 2 mg/kg (Diet 2) of body weight of the dog. Bone mineral density of individual dogs is measured annually by DEXA as described herein below. As younger dogs increase in average age from 4.0 to 7.0 years, maintenance and/or enhancement of bone mineral density is observed when consuming a nutritionally-balanced composition containing mannoheptulose at a level of 2 mg/kg of body weight. In contrast, a decline in bone mineral density is observed in younger dogs consuming a nutritionally-balanced composition devoid of mannoheptulose beginning after year 1 with a steady decline thereafter. Mannoheptulose provided as avocado extract in a nutritionally-balanced composition maintains and/or attenuates a decline in bone mineral density of younger dogs as they age.

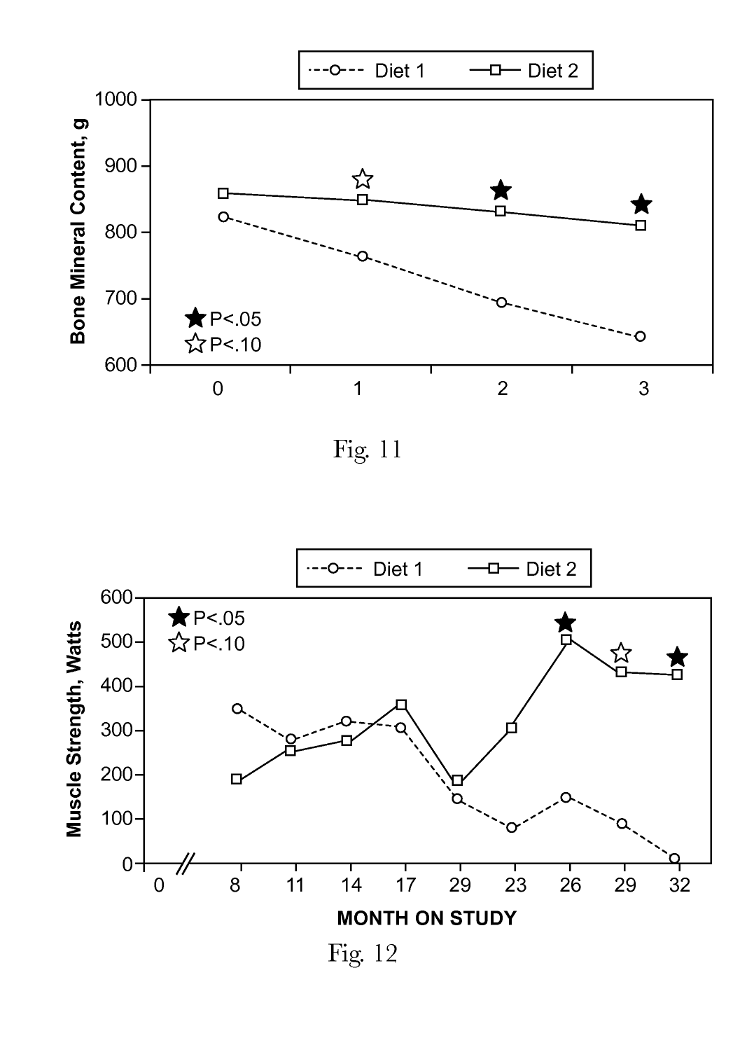

FIG. 11 is a graphical presentation of the average yearly bone mineral content of younger dogs over 3 years of feeding nutritionally-balanced compositions that provide mannoheptulose at levels of 0 mg/kg (Diet 1) or 2 mg/kg (Diet 2) of body weight of the dog. Bone mineral content of individual dogs is measured annually by DEXA as described herein below. As younger dogs increase in average age from 4.0 to 7.0 years, bone mineral content declines slightly when consuming a nutritionally-balanced composition containing mannoheptulose at a level of 2 mg/kg of body weight. In contrast, younger dogs consuming a nutritionally-balanced composition devoid of mannoheptulose show a decline in bone mineral content over 3 years. Mannoheptulose provided as avocado extract in a nutritionally-balanced composition maintains and/or attenuates a decline in the bone mineral content of younger dogs as they age.

FIG. 12 is a graphical presentation of the average muscle strength expressed as muscle power of younger dogs during 3 years of feeding nutritionally-balanced compositions that provide mannoheptulose at levels of 0 mg/kg (Diet 1) or 2 mg/kg (Diet 2) of body weight of the dog. Muscle strength of individual dogs is determined monthly beginning from month 6 as described herein below. Data are pooled quarterly for analysis and reporting beginning with month 8. By month 23, muscle strength is higher in younger dogs consuming a nutritionally-balanced composition containing mannoheptulose at a level of 2 mg/kg of body weight. Muscle strength continues to improve with long-term oral administration of mannoheptulose in a nutritionally-balanced composition. In contrast, muscle strength does not increase over time and declines following month 20 for younger dogs consuming a nutritionally-balanced composition devoid of mannoheptulose. Mannoheptulose provided as avocado extract in a nutritionally-balanced composition maintains and/or attenuates a decline in muscle strength of younger dogs as they age.

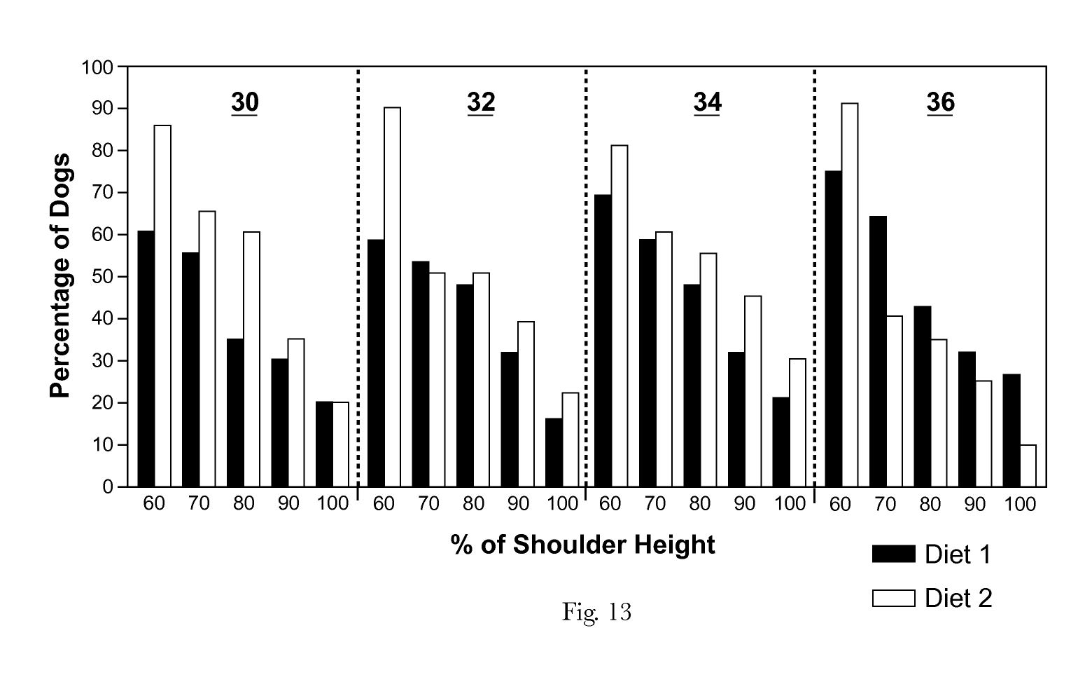

FIG. 13 is a graphical presentation of the percentage of younger dogs successfully jumping over various heights relative to their individual shoulder height during four consecutive quarters of a 3 year period of feeding nutritionally-balanced compositions that provide mannoheptulose at levels of 0 mg/kg (Diet 1) or 2 mg/kg (Diet 2) of body weight of the dog. Jumping ability of individual dogs is determined quarterly as described herein below. The initial assessment (start of first quarter) is made at month 22 of the study and continues for one year. The four consecutive quarters are represented as reference numbers 30, 32, 34 and 36, respectively, of FIG. 13.

Table 8 shows least-squares means for measured shoulder heights of younger dogs fed Diet 1 and Diet 2 and the probability value of the pair-wise comparison between the two groups. Shoulder height of the individual dog is used herein below as the standard to assess individual jumping ability. The maximum height successfully jumped by an individual dog is expressed as a percentage of their individual shoulder height. A reported p-value greater than 0.10 indicates no significant difference in shoulder height for younger dogs assigned to Diet 1 and Diet 2.

TABLE 8

| Younger dogs | Diet 1 | Diet 2 | P-value |
|---|---|---|---|
| Shoulder height, cm | 21.8 | 22.5 | 0.123 |

Table 9 shows the probability value for the pair-wise comparison across all four quarters for the percentage of younger dogs fed Diet 1 and Diet 2 that successfully jump a height relative to their shoulder height. The assessment of functional capacity is based on the ability of younger dogs to successfully jump heights that range from 60 to 100% of their individual shoulder height. A reported p-value less than or equal to 0.10 indicates a statistically significant difference between Diet 1 and Diet 2 across all four test quarters for the percentage of dogs successfully jumping similar heights. A reported p-value that is greater than 0.10 indicates similar jumping ability for both groups across all four quarters.

TABLE 9

| | Jumping height as a percentage | | | | |
|---|---|---|---|---|---|
| | of shoulder height, % | | | | |
| | 60 | 70 | 80 | 90 | 100 |
| P-value comparing Diet 1 vs. Diet 2 | .001 | .664 | .362 | .531 | .959 |

A greater percentage of younger dogs can successfully jump heights that are typically considered non-strenuous for normal, healthy dogs (60 or 70% of their shoulder height). As jumping height increases to 80, 90 or 100% of their shoulder height a smaller percentage of younger dogs can successfully jump these heights demonstrating a more demanding and physically challenging activity and/or test for younger dogs. With the exception of 60% of their shoulder heights, the percentage of younger dogs that successfully jump required height is similar regardless of the consumption of a nutritionally-balanced composition providing a level of mannoheptulose of 0 or 2 mg/kg of body weight. Only at a non-strenuous height of 60% of the individual shoulder can a greater percentage of younger dogs consuming Diet 2 outperform dogs consuming Diet 1. The benefit of maintaining and/or attenuating a decline in jumping ability is not sustained at higher height levels signifying a similar level of jumping ability in both groups of younger dogs.

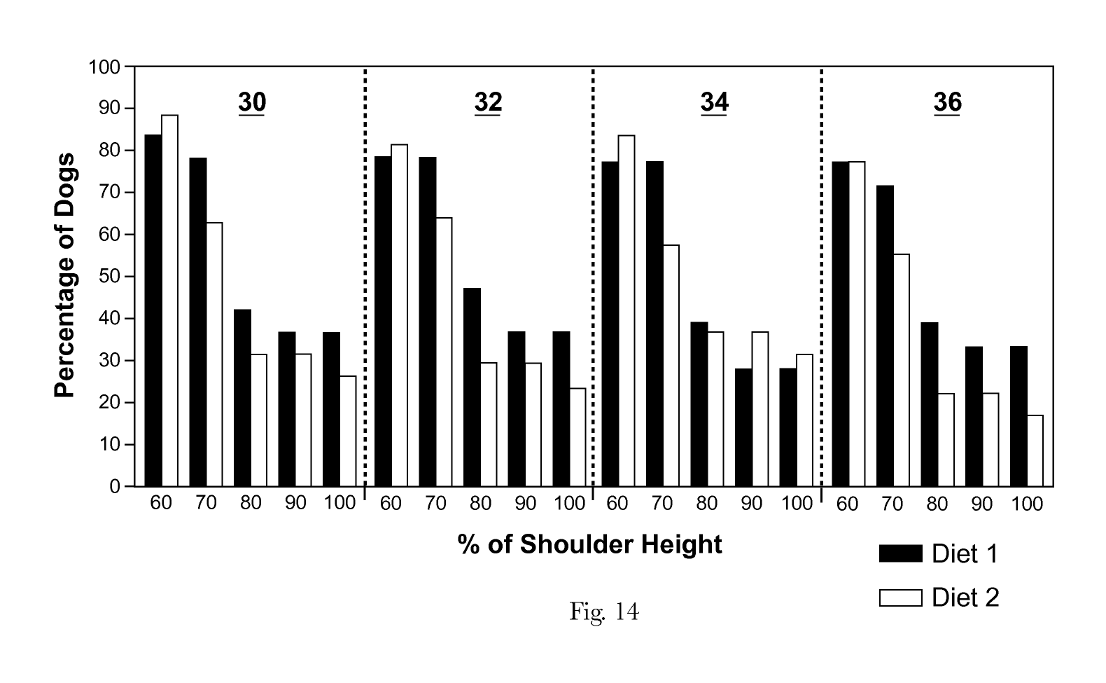

FIG. 14 is a graphical presentation of the percentage of younger dogs successfully jumping onto table platforms of varying heights relative to their shoulder height during 3 years of feeding nutritionally-balanced compositions that provide mannoheptulose at levels of 0 mg/kg (Diet 1) or 2 mg/kg (Diet 2) of body weight of the dog. Jumping ability of individual dogs is determined quarterly as described herein below. The initial assessment (start of first quarter) is made at month 22 of the study and continues for one year. The four consecutive quarters are represented as reference numbers 30, 32, 34 and 36, respectively, of FIG. 14.

Table 10 shows the probability value for the pair-wise comparison across all four quarters for the percentage of younger dogs fed Diet 1 and Diet 2 that successfully jump onto table platforms of increasing height relative to their individual shoulder height. The assessment of functional capacity is based on the ability of younger dogs to successfully jump onto table platforms of differing heights that range from 60 to 100% of their individual shoulder height. A reported p-value less than or equal to 0.10 indicates a statistically significant difference between Diet 1 and Diet 2 across all four test quarters for the percentage of dogs successfully jumping onto table platforms of similar heights. A reported p-value that is greater than 0.10 indicates similar jumping ability for both groups across all four quarters.

TABLE 10

| | Platform height as a percentage | | | | |
|---|---|---|---|---|---|
| | of shoulder height, % | | | | |
| | 60 | 70 | 80 | 90 | 100 |
| P-value comparing Diet 1 vs. Diet 2 | .554 | .031 | .144 | .642 | .230 |

A greater percentage of dogs can successfully jump onto table platform heights that are typically considered non-strenuous for normal, healthy dogs (60 or 70% of their shoulder height). As the platform height increases to 80, 90 or 100% of their individual shoulder height, a smaller percentage of younger dogs can successfully jump onto taller platforms demonstrating a more demanding and physically challenging activity and/or test for younger dogs. With the exception of 70% of their shoulder heights, the percentage of younger dogs able to successfully jump onto platforms of a specific height is similar regardless of the consumption of a nutritionally-balanced composition providing a level of mannoheptulose of 0 or 2 mg/kg of body weight. Only at a non-strenuous height of 70% of the individual shoulder height can a greater percentage of younger dogs consuming Diet 1 outperform dogs consuming Diet 2. The benefit of maintaining and/or attenuating a decline in jumping ability is not sustained at higher height levels signifying a similar level of jumping ability in both groups of younger dogs.

The similarity in jumping ability of the younger dogs fed Diet 1 and Diet 2 is likely dependent on their current ages. It is accepted by those skilled in the art that younger dogs are more likely to perform most physical tests and subtle differences in ability are not noticeable at younger ages. It can be expected that the jumping ability of younger dogs consuming the composition devoid of mannoheptulose (Diet 1) cannot be sustained due to declines in lean body mass, bone mineral density, bone mineral content, and muscle strength. It is expected declines in lean body mass, bone mineral density, bone mineral content, and muscle strength will manifest as a decline in functional mobility of the younger dogs as they age.

### Methods

### Animal Feeding Management

Dogs are subjected to a baseline period and fed a nutritionally-balanced composition devoid of mannoheptulose, avocado extract or avocado meal. The baseline feeding period is used to establish daily food allowance of individual dogs for maintaining ideal body weight and body condition ranges for each dog. An initial assessment by a licensed veterinarian determines the ideal range of body weight and body condition for each dog based on the breed standard for Labrador Retrievers and the body frame size of each dog. The daily food allowances can be adjusted as needed until the dog is within its ideal range of body weight and body condition. Once ideal body weight and body condition are achieved, the daily food allowance is fixed at that amount to maintain each dog within these ranges. The fixed daily food allowance is maintained during the remainder of the baseline period and the following test period. Adjustments to the fixed daily allowance may occur if the body condition of a dog falls outside an acceptable range of 2 to 4 as described in Table 11. Body condition score is evaluated quarterly according to criteria described in Table 11. The maximum allowable food adjustment for an individual dog is limited to +/−50 grams of food per day. The amount of this adjustment is dependent upon the dog's current body condition score relative to the preferred range of 2-4. The new food allowance is maintained for the next quarter before body condition scoring is repeated. This provision avoids large and rapid swings in food intake and helps to maintain each dog in a healthy and stable range of body weight and body condition through the feeding period.

TABLE 11

| Score | Description | Characteristics & Criteria |
|---|---|---|
| 1 | Extremely | Ribs, lumbar vertebrae, and pelvic bones visible at a distance and felt |
| | thin | without pressure |
| | | No palpable fat over tail base, spine or ribs |
| | | Obvious absence of muscle mass |
| | | Severe concave abdominal tuck when viewed from side |
| | | Severe hourglass shape when viewed from above |
| 2 | Underweight | Ribs palpable with little pressure, may be visible |
| | | Minimal palpable fat over ribs, spine, tail base |
| | | Increased concave abdominal tuck when viewed from side |
| | | Marked hourglass shape to waist when viewed from above |
| 3 | Ideal | Ribs and spine palpable with slight pressure but not visible, no excess |
| | | fat covering |
| | | Ribs can be seen with motion of dog |
| | | Good muscle tone apparent |
| | | Concave abdominal tuck when viewed from side |
| | | Smooth hourglass shape to waist when viewed from above |
| 4 | Overweight | Ribs palpable with slight excess fat covering which are difficult to feel |
| | | with palpation |
| | | General fleshy, stout appearance |
| | | Abdominal concave tuck is decreased to absent when viewed from the |
| | | side |
| | | Loss of hourglass shape to waist with back slightly broadened when |
| | | viewed from above |
| | | Ribs not seen with motion of the dog |
| 5 | Extremely | Ribs and spine not palpable under a heavy fat covering |
| | obese | Fat deposits visible over lumbar area, tail base and spine |
| | | Abdomen is convex with or without a pendulous ventral bulge |
| | | Back is markedly broadened |

### Dual Energy X-ray Absorptiometer (DEXA)

Whole-body composition measures of lean mass, fat, bone mineral density, and bone mineral content of adult dogs are obtained using Dual Energy X-ray Absorptiometer (DEXA). DEXA scans of anesthetized dogs are performed by a registered veterinary technician or a licensed veterinarian using a Hologic Delphi QDR® Series X-ray Bone Densitometer (Model Delphi-A, Serial No. 70852; Bedford, Mass.). A quality control calibration is completed prior to the start of the scan and standard operating procedures are followed as described in the User's Guide for X-Ray Bone Densitometer with QDR® for Windows®.

Dogs are fasted for a minimum of 12 hours prior to time of anesthesia and the DEXA scan. Fasting body weights are collected prior to anesthesia and recorded. Standard veterinary techniques are followed to provide safe and effective induction, maintenance, and recovery of anesthesia using appropriate sedation and tranquilization procedures for the dogs. Anesthetic supplies including needles, syringes, and artificial tears are assembled, as well as endotracheal tubes of various sizes.

The dog is sedated using a pre-anesthetic combination of Acepromazine (0.55 mg/kg intramuscular injection] and Atropine (0.04 mg/kg subcutaneous injection), then placed on the DEXA table. The dog is anesthetized using Propofol (7 mg/kg) administered via a secured intravenous catheter. The dog is intubated with an endotracheal tube and delivered 100% oxygen. A gas anesthesia machine is available in the event Isoflurane needs to be administered should the dog begin to recover prior to the scan being completed. Vital signs including respiratory rate and pulse are collected following induction with Propofol (before scan) and immediately after the 90-second scan.

The dog is positioned on its sternum with the head and neck as straight as possible. The forelimbs are rotated caudally and positioned at the dog's side. The hind limbs are extended and placed as straight as possible. The tail is straightened and placed between the hind limbs. The spine is positioned by the technician to be as straight as possible when viewed from a head-on position. If necessary, the technician will correct any curvature to the dog's body by re-positioning the dog. The length of the dog is measured from the tip of the nose to about one inch past the tip of the rear foot using a tape measure. These data are entered into the Hologic QDR Series program, according to standard procedures in the User's Guide for X-Ray Bone Densitometer with QDR® for Windows®. ‘Whole Body’ is selected as the scan type. The C-arm on the DEXA unit makes three passes over the dog in about 90 seconds, at which time the scan is complete.

Following DEXA, anesthesia is discontinued at the end of the procedure. Oxygen continues to be delivered to the dog for at least five minutes prior to being disconnected from the machine. The dog is moved to a recovery cage where the endotracheal tube is removed once the dog regains its swallowing reflex.

DEXA provides whole-body measures of bone mineral density, bone mineral content, total fat, lean body mass, lean body mass+bone mineral content, total mass, and percentage (%) of fat. The percentage (%) of whole-body lean is calculated as ‘Whole-Body Total Lean’/‘Whole-Body Total Mass’×100.

### Muscle Stength

Muscle strength, expressed as muscle power, of dogs is measured using a system comprised of a weight-pulling harness and a weight stack equipped with a pulley system. The following equipment is used to perform strength tests:
Dog weight-pulling harness: custom-made to a dog's body weight and body measurements; constructed of nylon material; a harness size for a typical adult Labrador Retriever, for example, will have a 25 inch circumference head hole with foam padding, and be 43 inches in length from center of neck to D-ring (PullDoggies.com)
Weight stack and pulley system: single pulley, free-standing, 150-pound weight stack, no boom (Therapy Systems; Roseville, Calif.) modified to accommodate a total weight of 75 pounds in 5 pound increments (additional 5 pound weights also by Therapy Systems)
Intercomp CS200 Force Meter (Intercomp Co.; Medina, Minn.)
Digital timer calibrated stop watch, model no. 61161-350 (Control Company, Friendswood, Tex.)
Turf spun roll, gray, 3 feet width×12 feet length×0.5 inches thickness, anti-fatigue matting (Scottissue, Inc.; Dayton, Ohio); customized by identifying length of matting in 0.10 meter increments using a permanent marking pen. A maximum pulling distance of 2.4 meters is also marked on the mat.
SitStay Clicker (SitStay, Inc.; Lincoln, Nebr.) positive reinforcement animal training clicker devices; or equivalent
Encouragement devices (eg, toys, diet kibble as treats)

Prior to performing the first strength test, each dog undergoes a multi-step training and acclimation process to familiarize the dog with the harness and the act of pulling weights. A dog is fitted to the harness and wears it during normal activities in an outdoor play yard. Once the dog is comfortable wearing the harness, an empty 1-gallon milk jug is attached to the harness to desensitize the dog to noises and sensations associated with pulling something. Increasing amounts of weight are added to the milk jug by adding pebbles. The dog is ready to perform the test once it successfully exhibits normal activity and play while pulling the pebble-filled milk jug. Time required to complete the acclimation process can range from days to weeks, depending on the personality of the individual dog.

All dogs are clicker trained. Clicker training is an animal training method based on behavioral psychology that relies on marking desirable behavior and rewarding it. Desirable behavior is marked by using a clicker, a mechanical device that makes a short, distinct ‘click’ sound, which tells the animal exactly when it is doing the right thing. This clear form of communication, combined with positive reinforcement, is an effective, safe, and humane way to teach any animal any behavior that it can physically and mentally perform. The human trainer clicks at the moment the behavior occurs, then delivers an appropriate reward (eg, food, human interaction, toy). Once dogs are trained, the clicker may no longer be needed on a daily basis, however, rewards are continued as positive reinforcement.

After dogs are trained and acclimated to the harness, pull weights, and the clicker positive reinforcement technique, a minimum of two technicians perform the two phases of the strength test: the step-up pull test and the repetition pull test. Each dog is fitted with a weight-pulling harness, which is then hooked to the weight stack and pulley system. Maximum peak pulling force is collected using a calibrated Intercomp CS200 Force Meter, operated according to standard operating procedures as described in Intercomp CS200 Users Manual. The force meter is reset after each pull attempt. Maximum peak pulling force is recorded but is not used in the calculation of work or power.

A step-up pull test is performed first. A successful pull is defined as the weight a dog can pull a distance of 2.4 meters within 30 seconds. One technician serves as the dog's handler and encourages the dog to begin pulling using various encouragement devices (eg, toys, diet kibble as treats, and/or vocal praise). At no time does the technician touch the dog to provide assistance. The second technician zeros the force meter and starts the stop watch when the dog takes its first step. When the dog reaches the 2.4 meter line the technician supports the pulled weight, to prevent the dog from being drawn backwards, while stopping the stop watch. The pull weight (lbs), pulling distance (2.4 m), elapsed time (s) and maximum peak pulling force (kg-force) are recorded by the technician. Weights are increased in five-pound increments (up to a maximum 75 pounds) until the dog is unsuccessful in completing the pull within the allotted distance and time. If a dog does not reach the 75-lb maximum, the pull weight, pulling distance, elapsed time and maximum peak pulling force are recorded for the final unsuccessful pull.

Upon completion of the step-up test, a repetition pull test is then performed. The pulling weight for the repetition test is returned to the maximum weight successfully pulled by the dog during the step-up pull test. Utilizing positive reinforcement, the dog pulls this same weight for a maximum of 10 times over the same 2.4 meter distance. Each repetitive pull must be completed within 30 seconds to be considered a successful pull. The time required to pull the weight the 2.4 meter distance is collected using the stop watch and recorded for each repetition. Maximum peak pulling force is recorded but is not used in the calculation of work or power. If a dog cannot perform all 10 repetitive pulls, the pull weight, pulling distance, elapsed time and maximum peak pulling force are recorded for the final unsuccessful pull.

Data collected are used to calculate the work performed and power exerted by each dog during each individual pull using the following equations.

Force (newtons)=Mass×Acceleration

Mass (kg)=individual weight successfully pulled by dog

Acceleration=9.80665 m/s²

Work (joules)=Force×Distance (m)

Power (watts)=Work/Time (s)

Total work and total power are calculated for each dog by summing all individual step-up and repetition pulls into an overall measure of muscle strength.

### Activities of Daily Living

Activities of daily living (ADL) measurements can be collected utilizing activities such as jumping onto platform tables (ADL-Table) or jumping over hurdles (ADL-Jump). These activities allow dogs to demonstrate their agility and ability to perform normal daily tasks. Activity measurements are designed to mimic common actions of dogs in a home environment and which typically become more difficult to perform as dogs age. A minimum of two technicians is required to conduct each activity test. One technician serves as the dog handler and one technician records data.

Prior to data collection, technicians train all dogs to perform the activities by using positive encouragement and reinforcement training techniques, such as clicker training as described previously. Dogs are guided through each activity by a handler who uses encouragement devices (eg, toys, diet kibbles as treats) and/or vocal praise. At no time does the handler touch the dog to provide assistance.

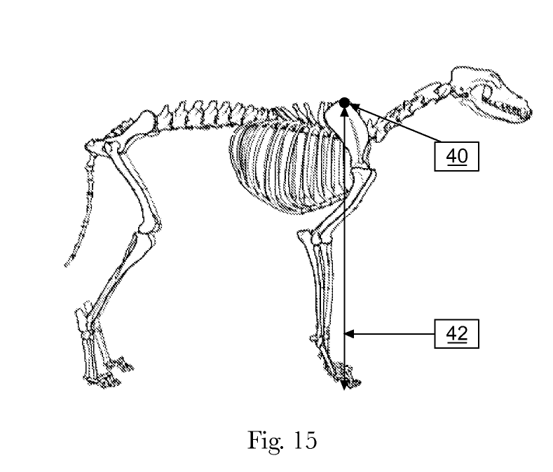

Shoulder height of each individual dog is measured using a tape measure and recorded. Shoulder height is defined as the distance 42 between the bottom of the right front leg (ground) to the proximal point of the scapular spine 40, as illustrated in FIG. 15.

The ADL-Table activity requires the dog to jump on to and down from the platform of four tables of graduated heights, starting with the lowest table height first. The ADL-Jump activity requires the dog to jump over a hurdle of incrementally increasing bar heights. Each of these two activities is described in more detail below. For both activities, dogs are scored for the number of attempts at each graduated height and the successful completion of each height.

The ADL-Table activity is conducted indoors in a room equipped with the following equipment:
One table (‘Low’) constructed of welded aluminum with skid-proof paint applied to a 3 feet×3 feet platform top (Agility-Equipment.com; Goffstown, N.H.). Height of Low table is 7 inches from the floor to the top of the platform surface.
One table (‘Medium’) constructed of welded aluminum with skid-proof paint applied to a 3 feet×3 feet platform top (Agility-Equipment.com; Goffstown, N.H.). Height of Medium table is 12 inches from the floor to the top of the platform surface.
One table (‘High’) constructed of welded aluminum with skid-proof paint applied to a 3 feet×3 feet platform top (Agility-Equipment.com; Goffstown, N.H.). Height of High table is 16 inches from the floor to the top of the platform surface.
One table (‘Highest’) constructed of welded aluminum with skid-proof paint applied to a 3 feet×3 feet platform top (Agility-Equipment.com; Goffstown, N.H.). Height of Highest table is 24 inches from the floor to the top of the platform surface.
Turf spun roll, gray, 0.5 inches thickness, anti-fatigue matting (Scottissue, Inc.; Dayton, Ohio)
Encouragement devices (eg, toys, assigned diet kibbles for treats)
Leashes

All tables are placed on gray matting to provide a non-slick and cushioned floor surface for the dogs. The mat (3 feet width×15 feet length) provides some protective cushioning for the dogs as they jump up onto and down from each table. A second mat (3 feet width×14.5 feet length) is stacked on top of the first mat and placed in front of the Medium, High and Highest tables for extra cushioning.

To perform the ADL-Table activity, the handler walks the dog on leash to the Low table. The handler may lightly hold on to the leash during the activity, depending upon the dog. The dog is encouraged to jump or climb on to the table using vocal praise, toy or treat. After jumping onto the platform the dog is encouraged to return to the floor by jumping or climbing down from the table. The dog is provided with two attempts to perform both activities to receive a successful score. The assessor records ‘Yes’ if the dog successfully jumps onto the structure and then jumps back to the floor. A “No” is recorded if the dog does not perform the task as described or makes no attempt to jump on to or from the structure. The number of attempts (1 or 2) is also recorded. If the dog successfully completes the activity at the Low table on its first or second attempt, the handler moves the dog immediately to the Medium table and repeats the same procedure. If the dog successfully completes the activity at the Medium table, the handler moves the dog immediately to the High table and repeats the same procedure. If the dog successfully completes the activity at the High table, the handler moves the dog immediately to the Highest table and repeats the same procedure. The test is completed when the dog successfully completes the activity on the Highest table or receives a “No” score on the two attempts for a structure. The highest platform table height successfully achieved by the dog is recorded. The highest successful height (inches) for a dog is expressed as a percentage of its measured shoulder height (inches).

The ADL-Jump activity is conducted indoors in a room equipped with the following:
Aluminum hurdle (jump) structure (Agility-Equipment.com; Goffstown, N.H.), 4 feet wide and fitted with slots for horizontal bars at the following heights (measured from the floor to the top of the bar):
   Level 1=7 inches
   Level 2=11 inches
   Level 3=15 inches
   Level 4=19 inches
   Level 5=21 inches
   Level 6=23 inches
   Level 7=25 inches
Seven PVC pipes, ¾ inches diameter×4 feet length that function as removable horizontal hurdle bars
Turf spun roll, gray, 0.5 inches thickness, anti-fatigue matting (Scottissue, Inc.; Dayton, Ohio)
Encouragement devices (ie, toys, assigned diet kibbles for treats)

The hurdle structure is placed on gray matting to provide a non-slick and cushioned floor surface for the dogs. Two mats (4.5 feet width×15 feet length) are double-stacked to provide a runway, jumping and landing areas with extra cushion as dogs perform this activity.

To perform the ADL-Jump activity, a hurdle bar is placed at the Level 1 position. The handler walks the dog on leash to a distance on the runway of approximately 6 to 8 feet from the hurdle. The dog is encouraged to jump over the hurdle using vocal praise, toy or treat. The handler does not touch the dog immediately before or during the activity. The handler may lightly hold on to the leash during the activity, depending upon the dog. To receive a successful score the dog must jump over the hurdle, without knocking the bar down, in no more than two attempts. The dog has two attempts to successfully jump over the hurdle. The assessor records ‘Yes’ if the dog successfully jumps the height without knocking the bar down. A score of ‘No’ is recorded if the dog does not attempt to jump the height or knocks the bar down. The number of attempts (1 or 2) is also recorded. If the dog successfully completes the Level 1 hurdle in its first or second attempt, a second hurdle bar is placed at the Level 2 and immediately repeats the same procedure. The same process is followed up to the Level 7 position or until the dog is unsuccessful in its two attempts at a specific height. The highest hurdle height successfully achieved by the dog is recorded. The highest successful height (inches) for a dog is expressed as a percentage of its measured shoulder height (inches).

### High Performance Liquid Chromatography Tandem Mass Spectometry (LC/MS/MS):

High performance liquid chromatography tandem mass spectrometry (HPLC/MS/MS) is utilized to determine the amount of mannoheptulose present in the plasma of adult dogs. D-mannoheptulose and its chemical analog internal standard (D₇-glucose) are isolated from dog plasma by a protein precipitation procedure (described herein below) using a 96-well format. The analyte and internal standard are subjected to reverse-phase high performance liquid chromatographic (HPLC) analysis on a polymeric amino column (2.1×150 mm, 5-μm particles). Detection and quantitation is by mass spectrometry (MS) operating under multiple reaction monitoring MS/MS conditions. Concentrations of D-mannoheptulose in dog plasma can be quantitated from approximately 20 to 5000 ng/mL. The assay requires a 0.1 mL aliquot of dog plasma harvested from a Na₂EDTA anti-coagulant blood collection tube. Specimen concentrations are determined by back-calculation using a weighted (1/x²) linear regression of a calibration curve generated from prepared D-mannoheptulose calibration standards.

The following reagents and apparatus are used to perform the analyses:

### Reagents

D-mannoheptulose Analytical Reference External Standard. Carbosynth, Compton-Berkshire, UK.
D-glucose-1,2,3,4,5,6,6-d7 (D₇-glucose), Method Reference Internal Standard (IS). Cambridge Isotope Laboratories, Andover Mass.
Acetonitrile (ACN). HPLC solvent; or equivalent
Formic Acid (FA), 88%, A.C.S. Reagent; or equivalent
Analytical Reagent Grade Water (ARW); or equivalent
Unfiltered Control (Blank) Dog Plasma with Na₂EDTA anti-coagulant. Bioreclamation; or equivalent
Needle Wash 1: (10:90) ACN:ARW with 0.05% FA
Needle Wash 2: (95:5) ACN:ARW with 0.1% FA
Mobile Phase A: ARW with 0.1% FA
Mobile Phase B: ACN with 0.1% FA

### Apparatus

Electronic Dispensing Pipettes (EDP), manual pipettes
HPLC pump. Shimadzu (Shimadzu; Kyoto, Japan) Model SCL-10A vp system controller & LC-10AD vp pumps with Gilson Model 81° C. mixer (65 μL volume)
Mass spectrometer. Sciex (Applied Biosystems/MDS SCIEX; Foster City, Calif.) API 4000 Q-Trap or instrument meeting equivalent sensitivity requirements using analyst software
Two Position Actuator. Valco Instruments Company Inc; Houston, Tex.)
Analytical Column. apHera NH₂ column (Sigma-Aldrich; St. Louis, Mo.), 2.1×150 mm (31m particle)
Screw Cap with Silicone O-Ring. VWR Scientific Products (West Chester, Pa.) Cat. No. 20170-241
Polypropylene Vials, Skirted Conical, Natural. 0.5 mL & 2 mL screw cap tubes with cap
Multi-Tube Vortexer. VWR Scientific Products (West Chester, Pa.) brand; or equivalent.
1.3 mL Round Well Round Bottom Polypropylene 96-well extraction/injection plates. (Microliter Analytical Supplies Inc; Suwanee, Ga.; Cat. No. 07-3000); or equivalent
Sealing Mat for 1.3 mL Deep 96 Round Well Collection Plates. (Whatman Polyfiltronics; Rockland, Md.; Cat. No. 7704-0105); or equivalent
Autosampler. CTC Analytics HTS PAL (Leap Technologies; Carrboro, N.C.); or equivalent
Centrifuge. Beckman Coulter (Beckman Coulter; Fullerton, Calif.) Alleger X-15 with Microplate Carrier and SX4750A Rotor; or equivalent

### Procedure

### 1. Preparation of D-Mannoheptulose Standard Stock Solution and Calibration Standards:

Prepare 0.500±0.100 mg/mL stock solutions of the D-mannoheptulose Analytical Reference External Standard in ARW water. Store the solutions in polypropylene vials at 2-4° C. until use. For each assay, prepare fresh D-mannoheptulose calibration standards using D-mannoheptulose stock solution and ARW water for final concentrations of 0.2, 0.4, 0.8, 2, 4, 8, 20, 40 and 50 ug/mL.

### 2. Preparation of D₇-Glucose Internal Standard (IS) Solutions

Stock D₇-Glucose (IS) Solution (1000 ug/mL):
Prepare 1.000±0.100 mg/mL solutions of D₇-glucose_Method Reference Standard in ARW water. Store the solutions in polypropylene vials at or below −70° C. until use.
   Working IS Solution (˜25 μg/mL):
Prepare 25 ug/mL solution using stock IS solution and ARW water. Store the solution at approximately 4° C. until use. The solution expires after 3 months.

### 3. Batch Preparation:

A study batch includes calibration standards, quality control (QC) samples, appropriate blanks, and study specimens. Samples can be transferred to their appropriate location in the 96-well plate manually. A study batch can contain a maximum of 96 samples, including calibration standards, QC samples, blanks and study specimens. Specimen and QC samples are thawed at room temperature.
Calibration Standards. Transfer 0.100 mL of each freshly-prepared calibration sample into its assigned position in the 96-well extraction plate.
Study Specimens and QC Samples. Samples are allowed to thaw at room temperature before pipetting. Dilute as necessary using ARW water. Transfer 0.100 mL of each sample into its assigned position in the 96-well extraction plate.
Blanks. Pipette 0.100 mL of ARW water into the reagent blank assigned position in the 96-well extraction plate. Pipette 0.100 mL of the appropriate control dog plasma into the positions assigned to plasma blank and zero standard.
Add 0.025 mL of ARW water to the Blank positions.
Add 0.025 mL of Working IS Solution to all positions of the 96-well extraction plate except the blank positions. Cover and vortex the plate for 15 seconds.
Add 0.500 mL of acetonitrile to all positions of the 96-well extraction plate for protein precipitation. Cover and vortex the plate for 15 seconds and then centrifuge at 3000 RPM for 10 minutes.
Transfer 0.400 mL of the supernatant from the 96-well extraction plate to the 96-well injection plate. Concentrate the supernatant to about 0.2 mL by nitrogen purge.
Cover the 96-well injection plate and vortex for 15 seconds.
Analyze all samples by HPLC/MS/MS analysis according to equipment specifications as described below.

### Analysis

To perform the analysis by HPLC/MS/MS, the instrument parameters listed below are used to analyze approximately 10 μL of each of the samples in the batch. From the MS data acquisition system, obtain the peak areas (PA) for D-mannoheptulose and internal standard in each sample.

HPLC Parameters - API 4000 Q-Trap Sciex
MS with Shimadzu Pump and Leap Injector

| | |
|---|---|
| Flow rate | 350 μL/min |
| Injection volume | 10 μL (the injection volume may be adjusted to |
| | optimize the HPLC/MS/MS sensitivity) |
| Run time (analyte | 6.0 min (~3.3 min for analyte and IS) |
| retention) | |
| Mobile Phase A | ARW with 0.1% Formic Acid |
| Mobile Phase B | ACN with 0.1% Formic Acid |
| Needle wash 1 | (10:90) ACN:ARW with 0.05% Formic Acid |
| Needle wash 2 | (95:5) ACN:ARW with 0.1% Forminc Acid |
| HPLC Column | Ambient |
| Temperature | |

Gradient

| Time | Mobile Phase A (%) | Mobile Phase B (%) | Divert Valve |
|---|---|---|---|
| 0.0 | 25 | 75 | To Waste |
| 0.1 | 25 | 75 | |
| 1.0 | | | To MS |
| 3.5 | 35 | 65 | |
| 3.51 | 50 | 50 | |
| 4.5 | 50 | 50 | |
| 4.5 | | | To Waste |
| 4.51 | 25 | 75 | |

Following are typical operating conditions (parameters) for the Sciex API 4000 Q-Trap mass spectrometers. These parameters may be adjusted to optimize the response; however, these parameters cannot be adjusted during a run, but rather a consistent set of instrument settings/parameters must be used for each run.

Mass Spectrometer Parameters

| Mass Spectrometer: | Sciex API 5000 |
|---|---|
| Ionization mode: | Turbo-Ion Spray-ESI |
| Polarity: | Negative |
| Turbo Temp: | 350° C. |
| CUR: | 45 |
| GS 1: | 35 |
| GS 2: | 60 |
| IS: | −3500 |
| CAD: | High |
| DP: | −25 |
| EP: | −11 |
| CE: | −10 |
| CXP: | −7 |

Ions used in MRM mode

| Compound | Parent Ion (m/z) | Product Ion (m/z) |
|---|---|---|
| D-mannoheptulose | 255.0 | 209.0 |
| D₇-glucose | 232.0 | 186.0 |

A weighted (1/x²) linear regression analysis for D-mannoheptulose in the calibration standards is performed in Watson LIMS, for the observed signal (defined here as the peak area ratio of each analyte to its internal standard) as a function of the analyte concentrations. The concentration of the analyte in the calibration standards, QC samples and study specimens is then back-calculated using the generated regression equation resident in Watson LIMS.

Run acceptance is assessed through evaluation of the standard calibration curve and QC sample read backs and satisfaction of the system suitability requirements that follow.

System suitability is assessed using performance qualification (PQ) solutions. PQ solution preparations are as follows:
Zero PQ=STD 0 from a sample set is used as a zero PQ.
Low PQ=the lowest standard from a sample set is used as a low PQ.
High PQ=the highest standard from a sample set is used as a high PQ.

Standards from single or various sample runs may be combined to make a PQ solution. The PQ samples are stored at 11° C. and are stable for the duration of the process stability.

A zero performance qualification (PQ) solution injection is first made followed by an injection of the low PQ solution. Instrument sensitivity is assured by detection of the analyte in the low PQ solution at a Signal to Noise (S/N) ratio of >4. Moreover, this detection indicates that each quadrupole, Q1 and Q3, is properly calibrated to transmit and detect the proper parent (Q1) and product (Q3) ions of the species being monitored. The high PQ solution is next injected followed by repeated injections of the zero PQ solution. The absence of carryover is assured by the lack of excessive ion current for the analyte in the last zero PQ solution injection (should be <35% of that signal seen in the low PQ solution injection). A response greater than 35% would warrant injector cleaning procedures, etc. prior to proceeding to specimen analysis.

Zero standards (control plasma), plasma matrix blanks and reagent blanks are analyzed for diagnostic purposes. Results from these analyses are not directly employed to determine run acceptance. However, no response >10% of the largest internal standard response seen in the zero standard injection(s) should appear at the known retention time of the internal standard in either of the control plasma or reagent blanks. In addition, at least one of the zero standards (control plasma) should not yield ion current at the retention time of the analyte that exceeds 50% of that response seen in the low standard injection.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising an effective amount of mannoheptulose wherein said effective amount of mannoheptulose provides a dosage to a mammal on a daily basis from about 0.001 gram per kilogram body weight of said mammal to about 1 gram per kilogram body weight of said mammal, wherein said composition is nutritionally balanced.

2. The composition of claim 1 wherein at least a portion of the mannoheptulose is derived from an avocado.

3. The composition of claim 1 wherein said composition is selected from the group consisting of dog food compositions and cat food compositions.

4. The composition of claim 1 wherein said composition is selected from the group consisting of kibbles, treats, moist foods, semi-moist foods, and combinations thereof.

5. The composition of claim 1 wherein said composition is at least partially extruded.

6. The composition of claim 1 wherein said mammal is selected from the group consisting of dog or cat.

7. The composition of claim 1 wherein said effective amount of mannoheptulose provides a dosage to said mammal on a daily basis from about 1 mg to about 200 mg per kg of body weight of said mammal.

8. The composition of claim 7 wherein said effective amount of mannoheptulose provides a dosage to said mammal on a daily basis from about 1 mg to about 20 mg per kg of body weight of said mammal.

9. The composition of claim 8 wherein said effective amount of mannoheptulose provides a dosage to said mammal on a daily basis from about 1 mg to about 15 mg per kg of body weight of said mammal.

10. A composition comprising an effective amount of mannoheptulose wherein said effective amount of mannoheptulose provides a dosage to a mammal on a daily basis from about 0.001 gram per kilogram body weight of said mammal to about 1 gram per kilogram body weight of said mammal, wherein said composition is a treat.

11. The composition of claim 10 wherein at least a portion of said mannoheptulose is derived from an avocado.

12. The composition of claim 10 wherein said mammal is selected from the group consisting of dog or cat.

13. The composition of claim 10 wherein said effective amount of mannoheptulose provides a dosage to said mammal on a daily basis from about 1 mg to about 200 mg per kg of body weight of said mammal.

14. The composition of claim 13 wherein said effective amount of mannoheptulose provides a dosage to said mammal on a daily basis from about 1 mg to about 20 mg per kg of body weight of said mammal.

15. The composition of claim 14 wherein said effective amount of mannoheptulose provides a dosage to said mammal on a daily basis from about 1 mg to about 15 mg per kg of body weight of said mammal.

16. A composition comprising an effective amount of mannoheptulose wherein said effective amount of mannoheptulose provides a dosage to a mammal on a daily basis from about 0.001 gram per kilogram body weight of said mammal to about 1 gram per kilogram body weight of said mammal, wherein said composition is at least partially extruded.

17. The composition of claim 16 wherein at least a portion of said mannoheptulose is derived from an avocado.

18. The composition of claim 16 wherein said mammal is selected from the group consisting of dog or cat.

19. The composition of claim 16 wherein said effective amount of mannoheptulose provides a dosage to a mammal on a daily basis from about 1 mg to about 200 mg per kg of body weight of said mammal.

20. The composition of claim 19 wherein said effective amount of mannoheptulose provides a dosage to a mammal on a daily basis from about 1 mg to about 20 mg per kg of body weight of said mammal.

21. The composition of claim 20 wherein said effective amount of mannoheptulose provides a dosage to a mammal on a daily basis from about 1 mg to about 15 mg per kg of body of said mammal.

22. A composition comprising an effective amount of mannoheptulose wherein said effective amount of mannoheptulose provides a dosage to a mammal on a daily basis from about 0.001 gram per kilogram body weight of said mammal to about 1 gram per kilogram body weight of said mammal wherein, said composition is in the form of a kibble.

23. The composition of claim 22 wherein at least a portion of said mannoheptulose is derived from an avocado.

24. The composition of claim 22 wherein said mammal is selected from the group consisting of dog or cat.

25. The composition of claim 22 wherein said effective amount of mannoheptulose provides a dosage to a mammal on a daily basis from about 1 mg to about 200 mg per kg of body weight of said mammal.

26. The composition of claim 25 wherein said effective amount of mannoheptulose provides a dosage to a mammal on a daily basis from about 1 mg to about 20 mg per kg of body weight of said mammal.

27. The composition of claim 26 wherein said effective amount of mannoheptulose provides a dosage to a mammal on a daily basis from about 1 mg to about 15 mg per kg of body of said mammal.

28. A composition comprising an effective amount of mannoheptulose wherein said effective amount of mannoheptulose provides a dosage to a mammal on a daily basis from about 0.001 gram per kilogram body weight of said mammal to about 1 gram per kilogram of body weight of said mammal, wherein said composition is a supplement.

29. The composition of claim 28 wherein at least a portion of said mannoheptulose is derived from an avocado.

30. The composition of claim 28 wherein said mammal is selected from the group consisting of dog or cat.

31. The composition of claim 28 wherein said effective amount of mannoheptulose provides a dosage to a mammal on a daily basis from about 1 mg to about 200 mg per kg of body weight of said mammal.

32. The composition of claim 31 wherein said effective amount of mannoheptulose provides a dosage to a mammal on a daily basis from about 1 mg to about 20 mg per kg of body weight of said mammal.

33. The composition of claim 32 wherein said effective amount of mannoheptulose provides a dosage to a mammal on a daily basis from about 1 mg to about 15 mg per kg of body of said mammal.

34. A composition comprising an effective amount of mannoheptulose wherein said effective amount of mannoheptulose provides a dosage to a mammal on a daily basis from about 0.001 gram per kilogram body weight of said mammal to about 1 gram per kilogram body weight of said mammal, wherein said composition is selected from the group consisting of gravies, drinking waters, yoghurts, powders, suspensions and combinations thereof.

35. The composition of claim 34 wherein at least a portion of said mannoheptulose is derived from an avocado.

36. The composition of claim 34 wherein said mammal is selected from the group consisting of dog or cat.

37. The composition of claim 34 wherein said effective amount of mannoheptulose provides a dosage to a mammal on a daily basis from about 1 mg to about 200 mg per kg of body weight of said mammal.

38. The composition of claim 37 wherein said effective amount of mannoheptulose provides a dosage to a mammal on a daily basis from about 1 mg to about 20 mg per kg of body weight of said mammal.

39. The composition of claim 38 wherein said effective amount of mannoheptulose provides a dosage to a mammal on a daily basis from about 1 mg to about 15 mg per kg of body of said mammal.
